(19) United States
(12) Patent Application Publication
(10) Pub. No.: US 2020/0403444 A1
(43) Pub. Date: Dec. 24, 2020

(54) POWER INTERCHANGE APPARATUS, COMPUTER READABLE STORAGE MEDIUM AND POWER INTERCHANGE METHOD

(71) Applicant: HONDA MOTOR CO.,LTD., Tokyo (JP)

(72) Inventors: Takayuki YAMADA, Saitama (JP); Koichiro TAKEMASA, Saitama (JP); Kazuyoshi MIYAJIMA, Saitama (JP); Keiichi TAKIKAWA, Tokyo (JP); Yuiko KOGA, Tokyo (JP)

(21) Appl. No.: 17/013,882

(22) Filed: Sep. 8, 2020

Related U.S. Application Data
(63) Continuation of application No. PCT/JP2019/002813, filed on Jan. 28, 2019.

(30) Foreign Application Priority Data
Mar. 19, 2018 (JP) 2018-051675

(51) Int. Cl. H02J 13/00; G06Q 10/02; G06Q 50/06

(52) U.S. Cl. CPC H02J 13/00002; H02J 13/00001; G06Q 10/02; H02J 2310/10; H02J 13/00036; H02J 13/00034; G06Q 50/06

(57) ABSTRACT

Included are: a performance information obtaining unit that obtains, for each of a plurality of first power customers that configure a first community, information about a power interchange performance between the first power customer and the first community; a contribution degree determination unit that determines a contribution degree of at least one of the plurality of first power customers to a surplus power amount of the first community in a certain time period, based on information about the performance obtained by the performance information obtaining unit.

The contents of the following Japanese patent application and International application are incorporated herein by reference:
NO. 2018-051675 filed in JP on Mar. 19, 2018; and
NO. PCT/JP2019/002813 filed on Jan. 28, 2019.

### BACKGROUND

### 1. Technical Field

The present invention relates to a power interchange apparatus, a computer readable storage medium and a power interchange method.

### 2. Related Art

A price management apparatus is known which calculates, for each distributed power source provided in each customer, compensation for power supplied to the utility grid from among power generated by a distributed power source (refer to Patent Document 1, for example).
Patent Document 1: Japanese Patent Application Publication No. 2011-176948

### BRIEF DESCRIPTION OF THE DRAWINGS

FIG. 1 schematically illustrates an example system configuration of an energy management system 100.

FIG. 2 schematically illustrates an example internal configuration of the customer facility 112.

FIG. 3 schematically illustrates an example internal configuration of the controller 240.

FIG. 4 schematically illustrates an example internal configuration of the energy management equipment 140.

FIG. 5 schematically illustrates an example internal configuration of the community management server 440.

FIG. 6 schematically illustrates an example internal configuration of the request processing unit 540.

FIG. 7 schematically illustrates an example internal configuration of the storage unit 560.

FIG. 8 schematically illustrates an example internal configuration of the interchange equipment 160.

FIG. 9 schematically illustrates an example internal configuration the wide area management server 180.

FIG. 10 schematically illustrates an example of the data table 1000.

FIG. 11 schematically illustrates an example of the data table 1100.

FIG. 12 schematically illustrates an example of the data table 1200.

FIG. 13 schematically illustrates an example of the data table 1300.

FIG. 14 schematically illustrates an example of the data table 1400.

FIG. 15 schematically illustrates an example of the data table 1500.

FIG. 16 schematically illustrates an example creating method of a power transmission/reception plan.

FIG. 17 schematically illustrates an example creating method of the power transmission/reception plan.

FIG. 18 schematically illustrates an example power procurement method in the community.

### DESCRIPTION OF EXEMPLARY EMBODIMENTS

Hereinafter, the present invention will be described through the embodiments of the invention. However, the following embodiments do not limit the claimed invention. In addition, all of the combinations of the features described in the embodiment are not necessarily required for the solution of the invention. It is noted that, in the drawings, the same or similar portions are provided with the same reference numerals and the redundant description may be omitted.

[Summary of the Energy Management System 100]

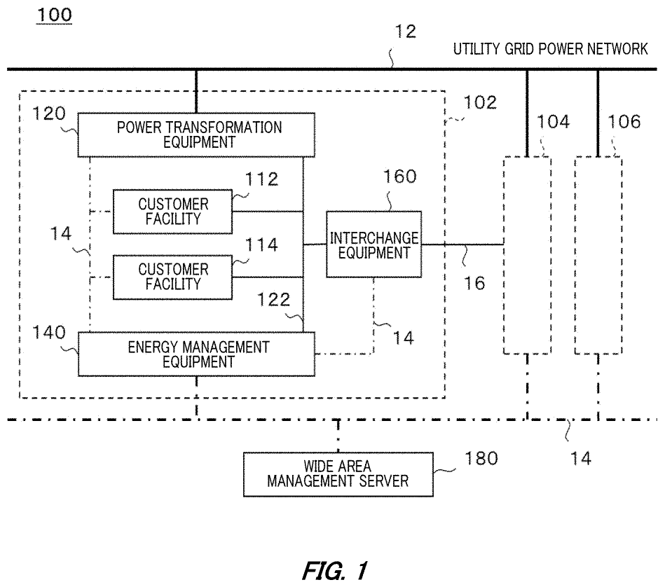

FIG. 1 schematically illustrates an example system configuration of an energy management system 100. In the present embodiment, the energy management system 100 includes a plurality of devices which configure a community 102 (which may be referred to as merely a community 102), a plurality of devices which configure a community 104 (which may be referred to as merely a community 104), and a plurality of devices which configure a community 106 (which may be referred to as merely a community 106). The energy management system 100 may also include a wide area management server 180.

In the present embodiment, the community 102 includes customer facility 112, customer facility 114, power transformation equipment 120, a power transmission/distribution network 122, energy management equipment 140, and interchange equipment 160. Each of a plurality of devices which configure the community 102 may transmit and receive information to/from each other via a communication network 14. The energy management equipment 140 of the community 102 may also transmit and receive information to/from other communities via the communication network 14. The energy management equipment 140 of the community 102 may transmit and receive information to/from the wide area management server 180 via the communication network 14.

In the present embodiment, the community 104 and the community 106 may have the configuration similar to that of the community 102, except for not including the interchange equipment 160. In the present embodiment, for the sake of simplicity of the description, the case will be described where the energy management system 100 includes the community 102, the community 104, and the community 106. However, the number of communities included in the energy management system 100 is not limited to the present embodiment. In another embodiment, the energy management system 100 includes one or a plurality of (which may be referred to as one or more) communities.

The energy management system 100 may include one or more communities 102. The energy management system 100 may include one or more communities 104. The energy management system 100 may include one or more communities 106. The energy management system 100 may not include the community 102. The energy management system 100 may not include the community 104. The energy management system 100 may not include the community 106.

In the present embodiment, for the sake of simplicity of the description, the case will be described where the community 102 includes the customer facility 112 and the customer facility 114. However, the number of customer facility included in the community 102 is not limited to the present embodiment. In another embodiment, the community 102 includes three or more customer facility.

The utility grid power network 12 may be an example power network of a commercial utility grid. Each of the community 102, the community 104 and the community 106 may be an example of either one of the first community or the second community. Each of the community 102, the community 104 and the community 106 may be an example of the other one of the first community or the second community. At least two of the community 102, the community 104 and the community 106 may be an example of a plurality of communities. The customer facility 112 may be an example of the first power customer or the second power customer. The customer facility 114 may be an example of the first power customer or the second power customer. The customer facility 112 and the customer facility 114 may be an example of a plurality of first power customers or a plurality of second power customers. The power transformation equipment 120 may be an example of the switching unit. The energy management equipment 140 may be an example of the switching unit and the power interchange apparatus.

The customer facility 112 may be an example of either one of the first user and the second user. The customer facility 114 may be an example of the other one of the first user and the second user. The owner, manager, operator or user of the customer facility 112 may be an example of either one of the first user and the second user. The owner, manager, operator or user of the customer facility 114 may be an example of the other one of the first user and the second user. The energy management equipment 140 may be an example of the condition determination apparatus.

In the present embodiment, the power transmission/distribution network 122 of the community 102 is electrically connected to the utility grid power network 12 via the power transformation equipment 120. In addition, the power transmission/distribution network 122 of the community 102 is electrically connected to a self supporting line 16 via the interchange equipment 160. In the present embodiment, the power transmission/distribution network 122 of the community 104 is electrically connected to the utility grid power network 12 via the power transformation equipment 120. In addition, the power transmission/distribution network 122 of the community 104 is electrically connected to the self supporting line 16, and is electrically connected to the interchange equipment 160 of the community 102 via the self supporting line 16. In the present embodiment, the power transmission/distribution network 122 of the community 106 is electrically connected to the utility grid power network 12 via the power transformation equipment 120.

According to the present embodiment, the community 102 and the community 104 can interchange power indirectly via the utility grid power network 12. In addition, the community 102 and the community 104 can interchange power to each other via the self supporting line 16. The community 102 and the community 106 can interchange power indirectly via the utility grid power network 12. The community 104 and the community 106 can interchange power indirectly via the utility grid power network 12.

Here, the matter “an element A and an element B are electrically connected” is not limited to the case where the element A and the element B are physically connected. For example, an input winding and an output winding of a voltage transformer are not physically connected, but electrically connected to each other. In addition, a component may be interposed between an element A and an element B for electrically connecting the element A with the element B. Examples of the component mentioned above can include a conductor, a breaker or a switch, a transformer, or other.

In the present embodiment, the utility grid power network 12 is electrically connected to the commercial power supply. The utility grid power network 12 may be a power grid provided by a power utility or a power transmission utility. The utility grid power network 12 may include a power grid of a plurality of power utilities or a plurality of power transmission utilities. The power grid may be an integrated system of power generation, power transformation, power transmission and power distribution.

In the present embodiment, the communication network 14 may be a wired communication transmission path, may be a wireless communication transmission path, or may be a combination of a wireless communication transmission path and a wired communication transmission path. The communication network 14 may include a wireless packet communication network, the Internet, a P2P network, a private line, a VPN, a power line, a communication line, or other. The communication network 14 may include (i) a mobile communication network such as a cellular phone line network, and may also include (ii) a wireless communication network such as a wireless MAN (WiMAX (registered trademark), for example), a wireless LAN (WiFi (registered trademark), for example), Bluetooth (registered trademark), Zigbee (registered trademark) or NFC (Near Field Communication).

In the present embodiment, each of the community 102, the community 104 and the community 106 may be a group which is configured by a plurality of customers. Members of each community have a common interest with respect to supply/demand of energy, for example Each of a plurality of customers owns, occupies or uses customer facility (the customer facility 112, the customer facility 114 or other, for example). A part of a plurality of customers may be a power retailer. The customer facility 112 and the customer facility 114 will be described in detail later.

In the present embodiment, the community is described in detail, taking as an example the case where each of the community 102, the community 104 and the community 106 configures a single community. However, the community is not limited to the present embodiment. In another embodiment, a single community may include a plurality of communities (the community 102, the community 104 or the community 106, for example). In addition, a plurality of power networks may be established within a single community, which can be disconnected from one another. Each of a plurality of power networks mentioned above may have the configuration similar to the power transmission/distribution network 122, for example.

In the present embodiment, the power transformation equipment 120 controls a power flow between the utility grid power network 12 and the power transmission/distribution network 122. An operation of the power transformation equipment 120 may be controlled by the energy management equipment 140.

In an embodiment, the power transformation equipment 120 receives a high voltage power of the utility grid power network 12 and converts at least one of a voltage and a frequency of the power. The power transformation equipment 120 makes the converted power flow over the power transmission/distribution network 122. In another embodiment, the power transformation equipment 120 receives a low voltage power of the power transmission/distribution network 122 and converts at least one of a voltage and a frequency of the power. The power transformation equipment 120 makes the converted power flow over the utility grid power network 12 (which may be referred to as reverse flow). In yet another embodiment, the power transformation equipment 120 switches electrical connections between the utility grid power network 12 and the power transmission/distribution network 122. This may switch between a state that the power transmission/distribution network 122 is disconnected from the utility grid power network 12 and a state that the power transmission/distribution network 122 is connected to the utility grid power network 12, for example.

In the present embodiment, the power transmission/distribution network 122 makes a power flow among a plurality of devices which configure the community 102. A part of the power transmission/distribution network 122 may be a power network owned or managed by the owner, the manager or the operator of the utility grid power network 12. At least a part of the power transmission/distribution network 122 may be a power network owned or managed by the community 102.

In the present embodiment, the energy management equipment 140 manages the energy used in the community 102. For example, the energy management equipment 140 manages the supply and demand of the energy used in the community 102. Examples of the energy can include electric power, gas, hydrogen, heat, or other.

In the present embodiment, the energy management equipment 140 manages the power used in the community 102. For example, the energy management equipment 140 manages the stability and quality of the power provided via the power transmission/distribution network 122. The energy management equipment 140 may manage the power supply/demand of the community 102. For example, the energy management equipment 140 manages the power transmission/reception, for example, between the power transmission/distribution network 122 and each of the customer facility 112 and the customer facility 114.

The energy management equipment 140 may monitor the state of the power supply/demand in the community 102 and adjust excess or deficiency of the power which flows over the power transmission/distribution network 122. In the present embodiment, the energy management equipment 140 may also aggregate or adjust the power supply/demand of a plurality of customer facilities. Equipment to aggregate or adjust the power supply/demand of a plurality of customer facilities may be referred to as an aggregator.

In the present embodiment, for the sake of simplicity of the description, the energy management system 100 and the energy management equipment 140 are described in detail, taking as an example the case where the energy management equipment 140 manages the power used in the community 102. However, the energy management system 100 and the energy management equipment 140 are not limited to the present embodiment. In another embodiment, the energy management equipment 140 may also manage energy other than electric power.

The energy management equipment 140 may output an instruction to the power transformation equipment 120, where the instruction is for the power transformation equipment 120 to switch the electrical connections between the utility grid power network 12 and the power transmission/distribution network 122. This allows the energy management equipment 140 to switch between a state that the power transmission/distribution network 122 is disconnected from the utility grid power network 12 and a state that the power transmission/distribution network 122 is connected to the utility grid power network 12, for example. The energy management equipment 140 will be described in detail later.

In the present embodiment, the interchange equipment 160 interchanges power between the community 102 and the community 104. The interchange equipment 160 may interchange power between the community 102 and the community 104, not via the utility grid power network 12. The interchange equipment 160 will be described in detail later.

In the present embodiment, the wide area management server 180 manages the stability and quality of the power provided via the utility grid power network 12. The wide area management server 180 may manage the power supply/demand of the utility grid power network 12. For example, the wide area management server 180 manages the power transmission/reception between the utility grid power network 12 and each of the community 102, the community 104 and the community 106. The wide area management server 180 may manage: (i) the power transmission from the utility grid power network 12 to each of the community 102, the community 104 and the community 106; and (ii) the power transmission from each of the community 102, the community 104 and the community 106 to the utility grid power network 12. The wide area management server 180 may monitor the state of the power supply/demand of the utility grid power network 12 and adjust excess or deficiency of the power which flows over the utility grid power network 12. The wide area management server 180 will be described in detail later.

[Specific configuration of each unit of the energy management system 100] Each unit of the energy management system 100 may be implemented by hardware, may be implemented by software, or may be implemented by hardware and software. At least a part of each unit of the energy management system 100 may be implemented by a single server or may be implemented by a plurality of servers. At least a part of each unit of the energy management system 100 may be implemented on a virtual machine or on a cloud system. At least a part of each unit of the energy management system 100 may be implemented by a personal computer or a mobile terminal. Examples of a mobile terminal include a cellular phone, a smart phone, a PDA, a tablet, a notebook computer or a laptop computer, a wearable computer, or other. Each unit of the energy management system 100 may store information by use of a distributed ledger technology or distributed network such as a block chain.

If at least a part of components which configure the energy management system 100 are implemented by software, the components implemented by the software may be implemented by activating a program which stipulates operations related to the components on an information processing apparatus having the general configuration. The information processing apparatus mentioned above includes, for example: (i) a data processing apparatus including a processor such as a CPU or a GPU, an ROM, an RAM, a communication interface, or other; (ii) an input apparatus such as a keyboard, a touch panel, a camera, a microphone, a sensor of every kind, and a GPS receiver; (iii) an output apparatus such as a display apparatus, a speaker or a vibration apparatus; and (iv) a storage apparatus (including an external storage apparatus) such as a memory or an HDD. In the information processing apparatus mentioned above, the data processing apparatus or the storage apparatus mentioned above may store a program. The program mentioned above may be stored in a non-transitory computer readable recording medium. The program mentioned above enables, when executed by a processor, the information processing apparatus mentioned above to perform an operation stipulated by the program.

The program may be stored in a computer-readable medium such as a CD-ROM, a DVD-ROM, a memory and a hard disk, or may be stored in a storage apparatus connected to the network. The program may be installed from a computer-readable medium or a storage apparatus connected to the network on a computer which configures at least a part of the energy management system 100. When the program is executed, a computer may function as at least a part of each unit of the energy management system 100. The program which enables a computer to function as at least a part of each unit of the energy management system 100 may include a module which stipulates an operation of each unit of the energy management system 100. The program or module acts on the data processing apparatus, the input apparatus, the output apparatus, the storage apparatus, or other to enable a computer to function as each unit of the energy management system 100 or enable a computer to perform the information processing method in each unit of the energy management system 100. Information processing described in the program functions, when the program is read into a computer, as a specific means in which software related to the program and every kind of hardware resources of the energy management system 100 are in cooperation. Then, the specific means mentioned above computes or processes information in accordance with the intended use of the computer in the present embodiment such that the energy management system 100 is established in accordance with the intended use.

[Summary of Each Unit of the Customer Facility]

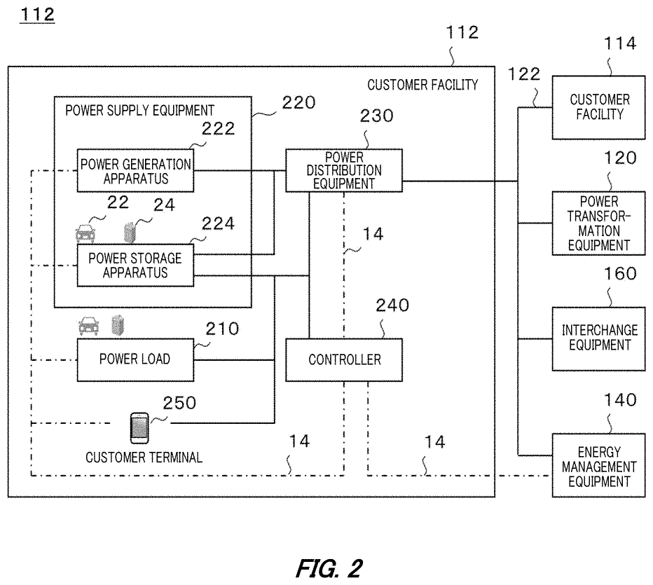

FIG. 2 schematically illustrates an example internal configuration of the customer facility 112. In the present embodiment, the customer facility 112 includes one or more power loads 210 and power supply equipment 220. The customer facility 112 may also include power distribution equipment 230, a controller 240, and one or more customer terminals 250. In the present embodiment, the power supply equipment 220 includes one or more power generation apparatuses 222 and one or more power storage apparatuses 224.

It is noted that the customer facility 112 may not include at least one of the components mentioned above. In an embodiment, the customer facility 112 may not include the power supply equipment 220. In another embodiment, the customer facility 112 may not include one of the power generation apparatus 222 and the power storage apparatus 224. In another embodiment, the customer facility 112 may not include the customer terminal 250. The customer facility 114 may have the configuration similar to that of the customer facility 112.

The power distribution equipment 230 may be an example of the supply/demand information obtaining unit and the performance information obtaining unit. The controller 240 may be an example of the supply/demand information obtaining unit and the performance information obtaining unit. The customer terminal 250 may be an example of the demand-side condition obtaining unit and the supply-side condition obtaining unit.

In the present embodiment, the power load 210 uses power. The power load 210 may be an electrical appliance which consumes power. The power load 210 may also be an electric vehicle 22, a portable storage battery 24, a charging device for charging the customer terminal 250, or other. An operation of at least a part of the power load 210 may be controlled by the controller 240. The electric vehicle 22 includes a storage battery. The portable storage battery 24 may be an example of portable device which includes a storage battery.

In the present embodiment, the power supply equipment 220 supplies power to other devices. The power provided by the power supply equipment 220 of the customer facility 112 may be: (i) used within the customer facility 112; (ii) provided to the outside of the customer facility 112 via the power distribution equipment 230 of the customer facility 112; or (iii) provided to the outside of the community 102 via at least one of the power transformation equipment 120 and the interchange equipment 160 of the community 102. An operation of the power supply equipment 220 may be controlled by the controller 240.

In the present embodiment, the power generation apparatus 222 generates power. Examples of the power generation apparatus 222 can include: (i) a power generation apparatus using reusable energy such as a solar power generation apparatus, a wind power generation apparatus, and a water power generation apparatus; (ii) a fuel cell; (iii) a co-generation system; (iv) a tri-generation system, or other.

In the present embodiment, the power storage apparatus 224 stores power. The power storage apparatus 224 may store: (i) power generated by the power generation apparatus 222 of the customer facility 112; or (ii) power provided from the outside of the customer facility 112. In the present embodiment, the power storage apparatus 224 supplies power to other devices. The power provided by the power storage apparatus 224 of the customer facility 112 may be: (i) used within the customer facility 112; (ii) provided to the outside of the customer facility 112 via the power distribution equipment 230 of the customer facility 112; or (iii) provided to the outside of the community 102 via at least one of the power transformation equipment 120 and the interchange equipment 160 of the community 102.

In the present embodiment, the power storage apparatus 224 may include: (i) fixed or add-on power storage equipment; (ii) an electric vehicle 22; (iii) a portable storage battery 24, or other. If the electric vehicle 22 or the portable storage battery 24 is electrically connected to the power supply equipment 220, at least one of the dischargeable amount (may be referred to as the remaining amount) and the chargeable amount of the power storage apparatus 224 increases. If the electric vehicle 22 or the portable storage battery 24 is electrically disconnected from the power supply equipment 220, at least one of the dischargeable amount (may be referred to as the remaining amount) and the chargeable amount of the power storage apparatus 224 decreases.

In the present embodiment, the power distribution equipment 230 controls a power flow between the power transmission/distribution network 122 and the wiring within the customer facility 112. An operation of the power distribution equipment 230 may be controlled by the controller 240.

In an embodiment, the power distribution equipment 230 receives power supply from the power transmission/distribution network 122. The power distribution equipment 230 supplies power to an electrical appliance provided within the customer facility 112. The power distribution equipment 230 may also adjust at least one of a voltage and a frequency of the power supplied to the electrical appliance provided within the customer facility 112. The power distribution equipment 230 may convert an alternate current to a direct current, or may convert a direct current to an alternate current.

In another embodiment, the power distribution equipment 230 receives power supply from the power supply equipment 220 of the customer facility 112. The power distribution equipment 230 supplies power to the power transmission/distribution network 122. The power distribution equipment 230 may also adjust at least one of a voltage and a frequency of the power supplied to the power transmission/distribution network 122. The power distribution equipment 230 may convert an alternate current to a direct current, or may convert a direct current to an alternate current.

In yet another embodiment, the power distribution equipment 230 controls a current amount supplied to the inside of the customer facility 112. The power distribution equipment 230 may switch electrical connections between the power transmission/distribution network 122 and the wiring within the customer facility 112. For example, the power distribution equipment 230 includes a circuit breaker to shut off a current which flows through the power distribution equipment 230 if a value of the current exceeds an arbitrary threshold. The threshold mentioned above may be set by the controller 240 at an arbitrary timing.

In the present embodiment, the power distribution equipment 230 may measure at least one of an instantaneous power [kW] and a power amount [kWh] of the power supplied to the electrical appliance provided within the customer facility 112. The power distribution equipment 230 may measure at least one of an instantaneous power [kW] and a power amount [kWh] of the power supplied to the power transmission/distribution network 122. The power distribution equipment 230 may include one or a plurality of power amount meters. The power distribution equipment 230 may output information indicating at least one of the measured instantaneous power [kW] and power amount [kWh] to the controller 240. The power distribution equipment 230 and the controller 240 may transmit and receive information via the communication network 14.

In the present embodiment, the controller 240 controls at least a part of devices provided within the customer facility 112. The controller 240 may also monitor a state of at least a part of the devices provided within the customer facility 112. The controller 240 may transmit and receive information to/from each device via the communication network 14. The controller 240 will be described in detail later.

In the present embodiment, the controller 240 may perform every kind of information processing in cooperation with the energy management equipment 140. However, assignment of the information processing performed in the energy management equipment 140 and the information processing performed in the controller 240 is not limited to the present embodiment. In another embodiment, the controller 240 may perform a part of the information processing of the energy management equipment 140 in the present embodiment, while the energy management equipment 140 may perform a part of the information processing of the controller 240 in the present embodiment.

The controller 240 may be implemented by hardware, may be implemented by software, or may be implemented by hardware and software. If at least a part of the components which configure the controller 240 are implemented by software, the components implemented by the software may be implemented by activating a program which stipulates operations related to the components on an information processing apparatus having the general configuration.

The information processing apparatus mentioned above includes, for example: (i) a data processing apparatus including a processor such as a CPU or a GPU, an ROM, an RAM, a communication interface, or other; (ii) an input apparatus such as a keyboard, a touch panel, a camera, a microphone, a sensor of every kind, and a GPS receiver; (iii) an output apparatus such as a display apparatus, a speaker or a vibration apparatus; and (iv) a storage apparatus (including an external storage apparatus) such as a memory or an HDD. In the information processing apparatus mentioned above, the data processing apparatus or the storage apparatus mentioned above may store a program. The program mentioned above may be stored in a non-transitory computer readable recording medium. The program mentioned above is executed by a processor to enable the information processing apparatus mentioned above to perform an operation stipulated by the program. The program mentioned above may be a program for making a computer perform one or a plurality of procedures related to every kind of information processing of the controller 240.

In the present embodiment, the customer terminal 250 is a communication terminal used by a user of the customer facility 112, and not particularly limited for details. Examples of the customer terminal 250 can include a personal computer, a mobile terminal, or other. Examples of a mobile terminal can include a cellular phone, a smart phone, a PDA, a tablet, a notebook computer or a laptop computer, a wearable computer, or other. The customer terminal 250 may be used as a user interface of the controller 240. The customer terminal 250 may be an example of the power load 210.

In an embodiment, the customer terminal 250 transmits and receives information to/from the controller 240 via the communication network 14. In another embodiment, the customer terminal 250 transmits and receives information to/from the energy management equipment 140 via the communication network 14.

In the present embodiment, the customer terminal 250 will be described in detail, taking as an example the case where the customer terminal 250 is used as a user interface of the controller 240. However, the customer terminal 250 is not limited to the present embodiment. In another embodiment, a part of or entire functions of the controller 240 may be implemented by the customer terminal 250. In yet another embodiment, a part of or entire functions of the energy management equipment 140 may be implemented by the customer terminal 250.

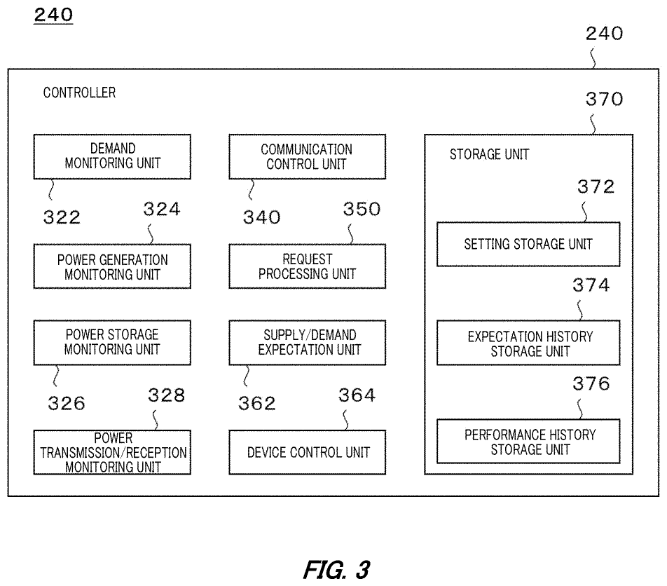

FIG. 3 schematically illustrates an example internal configuration of the controller 240. In the present embodiment, the controller 240 includes a demand monitoring unit 322, a power generation monitoring unit 324, a power storage monitoring unit 326, and a power transmission/reception monitoring unit 328. In the present embodiment, the controller 240 includes a communication control unit 340, a request processing unit 350, a supply/demand expectation unit 362, a device control unit 364, and a storage unit 370. In the present embodiment, the storage unit 370 may include a setting storage unit 372, an expectation history storage unit 374, and a performance history storage unit 376.

The demand monitoring unit 322 may be an example of the supply/demand information obtaining unit. The power generation monitoring unit 324 may be an example of the supply/demand information obtaining unit. The power storage monitoring unit 326 may be an example of the supply/demand information obtaining unit. The power transmission/reception monitoring unit 328 may be an example of the performance information obtaining unit. The supply/demand expectation unit 362 may be an example of the expectation information obtaining unit.

The supply/demand expectation unit 362 may be an example of the first supply/demand expectation obtaining unit and the second supply/demand expectation obtaining unit. The request processing unit 350 may be an example of the demand-side condition obtaining unit and the supply-side condition obtaining unit.

In the present embodiment, the demand monitoring unit 322 monitors power demand of the customer facility 112. The demand monitoring unit 322 obtains information about the power demand of the customer facility 112. The information about the power demand may be an example of the information about the power supply/demand. The demand monitoring unit 322 may obtain the information mentioned above when a predetermined event occurs. Examples of the predetermined event can include: (i) reaching a predetermined clock time; (ii) lapse of a predetermined time period since the information mentioned above was obtained previously; (iii) receiving an instruction from the customer terminal 250 to obtain the information mentioned above, or other.

For example, the demand monitoring unit 322 obtains, for each unit time period, the information about the power used by one or more power loads 210 in the time period. The demand monitoring unit 322 may obtain the information mentioned above from the power load 210 or the power distribution equipment 230. For example, the demand monitoring unit 322 obtains the information about the power used in each unit time period, from each of one or more power loads 210. The demand monitoring unit 322 may also obtain the information about the power supplied to one or more power loads 210 in each unit time period, from the power distribution equipment 230.

Examples of the information about the power can include information indicating a statistical value of an instantaneous power [kW] in each unit time period, a power amount [kWh] in each unit time period, or other. Examples of the statistical value can include a maximum value, a minimum value, an average value, a mean value, a mode value, dispersion, or other. It is noted that [kW] is used as a unit of the instantaneous power for the sake of simplicity of the description, but other units may also be used. Similarly, [kWh] is used as a unit of the power amount, but other units may also be used.

A length of the unit time period is not particularly limited. The unit time period may be five minutes, 10 minutes, 15 minutes, 30 minutes, one hour, two hours, three hours, six hours, 12 hours, or one day.

The demand monitoring unit 322 may store information about the power demand of the customer facility 112 in the performance history storage unit 376. The demand monitoring unit 322 may store the information about the power demand of the customer facility 112 in the performance history storage unit 376, to be associated with information indicating the clock time or the time period when the power is used.

In the present embodiment, the power generation monitoring unit 324 monitors power supply of the customer facility 112. The power generation monitoring unit 324 obtains information about the power supply of the customer facility 112. The power generation monitoring unit 324 may obtain the information mentioned above when a predetermined event occurs. The power generation monitoring unit 324 may also obtain, for each unit time period, the information about the power generated by the power generation apparatus 222 in the time period. The power generation monitoring unit 324 may obtain the information mentioned above from the power supply equipment 220, the power generation apparatus 222 or the power distribution equipment 230. The information about the power supply may be an example of the information about the power supply/demand. The predetermined event, the information about the power, and the unit time period may be as set forth above for details.

The power generation monitoring unit 324 may store information about the power supply of the customer facility 112 in the performance history storage unit 376. The power generation monitoring unit 324 may store the information about the power supply of the customer facility 112 in the performance history storage unit 376, to be associated with information indicating the clock time or the time period when the power is supplied. The clock time or the time period mentioned above when the power is supplied may be a power generation clock time or a power generation time period of the power generation apparatus 222.

In the present embodiment, the power storage monitoring unit 326 monitors at least one of the power demand and the power supply of the customer facility 112. The power storage monitoring unit 326 may also obtain information about at least one of the power demand and the power supply of the customer facility 112. The power storage monitoring unit 326 may obtain the information mentioned above when a predetermined event occurs. In an embodiment, the power storage monitoring unit 326 obtains, for each unit time period, information about power charged by the power storage apparatus 224 in the time period. In another embodiment, the power storage monitoring unit 326 obtains, for each unit time period, information about power discharged by the power storage apparatus 224 in the time period.

The power storage monitoring unit 326 may obtain the information mentioned above from the power supply equipment 220, the power storage apparatus 224 or the power distribution equipment 230. At least one of the information about the power demand and the power supply may be an example of the information about the power supply/demand. The information about the power charged by the power storage apparatus 224 may be an example of the information about the power demand. The information about the power discharged by the power storage apparatus 224 may be an example of the information about the power supply. The predetermined event, the information about the power, and the unit time period may be as set forth above for details.

The power storage monitoring unit 326 may store information about the power demand of the customer facility 112 in the performance history storage unit 376. The power storage monitoring unit 326 may store the information about the power demand of the customer facility 112 in the performance history storage unit 376, to be associated with information indicating the clock time or the time period when the power is used. The clock time or the time period mentioned above when the power is used may be a charging clock time or a charging time period of the power storage apparatus 224.

The power storage monitoring unit 326 may store information about the power supply of the customer facility 112 in the performance history storage unit 376. The power storage monitoring unit 326 may store the information about the power supply of the customer facility 112 in the performance history storage unit 376, to be associated with information indicating the clock time or the time period when the power is supplied. The clock time or the time period mentioned above in which the power is supplied may be a discharging clock time or a discharging time period of the power storage apparatus 224.

The power storage monitoring unit 326 may obtain information about a chargeable/dischargeable power amount [kWh] of the power storage apparatus 224. The dischargeable power amount of the power storage monitoring unit 326 may be referred to as a remaining amount of the stored power [kWh]. The chargeable power amount of the power storage monitoring unit 326 may be referred to as an unoccupied capacity [kWh]. The remaining amount of the stored power can be determined based on an SOC (State of Charge) of the power storage apparatus 224, for example. The unoccupied capacity of the power storage apparatus 224 can be determined by removing the remaining amount of the stored power of the power storage apparatus 224 from the rated capacity of the power storage monitoring unit 326 or the practical upper limit value related to the capacity of the power storage apparatus 224, for example.

The power storage monitoring unit 326 may obtain the information mentioned above when a predetermined event occurs. In an embodiment, the power storage monitoring unit 326 obtains information about the remaining amount of the stored power of the power storage apparatus 224 at a predetermined interval. In another embodiment, the power storage monitoring unit 326 obtains information about the unoccupied capacity of the power storage apparatus 224 at a predetermined interval.

The power storage monitoring unit 326 may obtain the information mentioned above from the power supply equipment 220, the power storage apparatus 224 or the power distribution equipment 230. The information about the remaining amount of the stored power and the information about the unoccupied capacity may be an example of the information about the power supply/demand. The predetermined event, the information about the power, and the unit time period may be as set forth above for details.

The power storage monitoring unit 326 may store information about a chargeable/dischargeable power amount of the power storage apparatus 224 in the performance history storage unit 376. The power storage monitoring unit 326 may store the information about the chargeable/dischargeable power amount of the power storage apparatus 224 in the performance history storage unit 376, to be associated with the information indicating the clock time or the time period when the power amount is measured.

In the present embodiment, the power transmission/reception monitoring unit 328 monitors power transmission/reception between the customer facility 112 and the outside of the customer facility 112. Examples of the outside of the customer facility 112 can include the other devices of the community 102, the community 104, the community 106, or other. Examples of the other devices of the community 102 can include the customer facility 114, the power transformation equipment 120, the energy management equipment 140, the interchange equipment 160, or other. Interchange of power between the customer facility 112 and the other devices of the community 102 via the power transmission/distribution network 122 may be referred to as power interchange between the customer facility 112 and the community 102.

The power transmission/reception monitoring unit 328 obtains information about power transmission/reception of the customer facility 112. In an embodiment, the power transmission/reception monitoring unit 328 obtains information about power which the customer facility 112 transmits to the outside of the customer facility 112. For example, the power transmission/reception monitoring unit 328 obtains from the power distribution equipment 230, information about the power which the customer facility 112 supplies to the power transmission/distribution network 122. In another embodiment, the power transmission/reception monitoring unit 328 obtains information about the power which the customer facility 112 receives from the outside of the customer facility 112. For example, the power transmission/reception monitoring unit 328 obtains from the power distribution equipment 230, information about the power supplied from the power transmission/distribution network 122 to the customer facility 112. The information about the power transmission/reception of customer facility 112 may be an example of the information about the power interchange performance.

The power transmission/reception monitoring unit 328 may obtain the information mentioned above when a predetermined event occurs. In an embodiment, the power transmission/reception monitoring unit 328 obtains, for each unit time period, information about power which the customer facility 112 transmits to the outside of the customer facility 112 in the time period. In another embodiment, the power transmission/reception monitoring unit 328 obtains, for each unit time period, information about power discharged by the power storage apparatus 224 in the time period. The predetermined event, the information about the power, and the unit time period may be as set forth above for details.

The power transmission/reception monitoring unit 328 may store information about the power transmission/reception of the customer facility 112 in the performance history storage unit 376. The power transmission/reception monitoring unit 328 may store information about the power transmission/reception of the customer facility 112 in the performance history storage unit 376, to be associated with the clock time or the time period of the power transmission/reception.

The information about the power transmission/reception may include information in which identification information of the power transmission side, identification information of the power receiving side, information indicating the time period in which the power is transmitted or received, and information indicating the power transmission amount or the power reception amount are associated. The information indicating the time period when the power is transmitted or received may be an example of the information indicating the time period in which the power is interchanged. The information indicating the power transmission amount or the power reception amount may be an example of the information indicating the interchanged power amount.

In the present embodiment, the communication control unit 340 controls communication between the controller 240 and the other devices. The communication control unit 340 may be a communication interface of every kind. The communication control unit 340 may support one or a plurality of communication systems. In an embodiment, the communication control unit 340 controls communication between the controller 240 and the other devices provided within the customer facility 112. In another embodiment, the communication control unit 340 controls communication between the controller 240 and the energy management equipment 140.

In the present embodiment, the request processing unit 350 receives every kind of requests from the other devices and processes the requests. In an embodiment, the request processing unit 350 processes a request from the other devices provided within the customer facility 112. For example, the request processing unit 350 processes a request from the customer terminal 250. The request processing unit 350 may transmit a request of every kind for the other devices of the community 102 in response to a request from the customer terminal 250. In another embodiment, the request processing unit 350 processes a request from other devices outside of the customer facility 112. For example, the request processing unit 350 processes a request from the customer facility 114 or the energy management equipment 140.

In the present embodiment, the supply/demand expectation unit 362 expects at least one of power demand and power supply of the customer facility 112 at a future clock time or in a future time period. The clock time or the time period subject to expectation may be referred to as an expectation time. The supply/demand expectation unit 362 may store the expected result in the storage unit 370. The supply/demand expectation unit 362 may store information indicating the expectation time and the expected result which corresponds to the expectation time in the storage unit 370, to be associated with each other.

In an embodiment, the supply/demand expectation unit 362 expects the power demand of the customer facility 112 at the expectation time, based on information about the power demand of the customer facility 112 in an arbitrary past time period (which may be referred to as a demand performance). The supply/demand expectation unit 362 may expect at least one of a statistical value of the instantaneous power and a power supply/demand amount at the expectation time. The supply/demand expectation unit 362 may expect the power demand of the customer facility 112 at the expectation time, based on (A) the demand performance of the customer facility 112; and (B) at least one of: (i) information about the power supply of the customer facility 112 in an arbitrary past time period (which may be referred to as a supply performance) and (ii) weather information of an area where the customer facility 112 is located and of a time period which includes the expectation time.

In another embodiment, the supply/demand expectation unit 362 expects the power supply of the customer facility 112 at the expectation time, based on the supply performance of the customer facility 112. The supply/demand expectation unit 362 may expect at least one of a statistical value of the instantaneous power and a power supply amount at the expectation time. The supply/demand expectation unit 362 may expect the power supply of the customer facility 112 at the expectation time, based on (A) the supply performance of the customer facility 112; and (B) at least one of: (i) the demand performance of the customer facility 112 and (ii) weather information of an area where the customer facility 112 is located and of a time period which includes the expectation time. The supply/demand expectation unit 362 may store the expected result in the storage unit 370.

In yet another embodiment, the supply/demand expectation unit 362 expects a chargeable/dischargeable power amount of the power storage apparatus 224 of the customer facility 112 at the expectation time, based on the demand performance and the supply performance of the customer facility 112. The supply/demand expectation unit 362 may expect at least one of a statistical value of the instantaneous power, a remaining amount of the stored power and an unoccupied capacity at the expectation time. The supply/demand expectation unit 362 may store the expected result in the storage unit 370. The expectation history storage unit 374 may store an expected value of at least one of the remaining amount of the stored power and the unoccupied capacity of the customer facility 112.

In yet another embodiment, the supply/demand expectation unit 362 expects power transmission/reception between the customer facility 112 and the community 102 at the expectation time, based on the demand performance and the supply performance of the customer facility 112. The supply/demand expectation unit 362 may expect at least one of a statistical value of the instantaneous power, a power transmission amount and a power reception amount at the expectation time. The supply/demand expectation unit 362 may store the expected result in the storage unit 370.

The supply/demand expectation unit 362 may obtain the demand performance from the demand monitoring unit 322, the power storage monitoring unit 326, or the performance history storage unit 376. The demand performance may include information about the power used to charge the power storage apparatus 224. The supply/demand expectation unit 362 may obtain the supply performance from the power generation monitoring unit 324, the power storage monitoring unit 326, or the performance history storage unit 376. The supply performance may include information about the power discharged by the power storage apparatus 224. The supply/demand expectation unit 362 may obtain weather information of an area where the customer facility 112 is located and of a time period which includes the expectation time, from an external information delivery apparatus which delivers weather information of each area.

In the present embodiment, the device control unit 364 controls one or more devices provided within the customer facility 112. The device control unit 364 may generate an instruction for controlling at least one of one or more devices provided within the customer facility 112. The device control unit 364 may transmit the generated instruction to a device which corresponds to the instruction.

In the present embodiment, the storage unit 370 stores every kind of information. The storage unit 370 may also perform processes such as generation, update, deletion and retrieval of information. For example, the storage unit 370 performs: (i) receiving an extraction request which includes an extraction condition; (ii) extracting information which matches the extraction condition from the information stored in the storage unit 370; and (iii) transmitting the extracted information to a source of the extraction request.

In the present embodiment, the setting storage unit 372 stores information about a setting of energy management in the customer facility 112. The setting storage unit 372 may store information about a specification or a setting of each of the devices within the customer facility 112. The setting storage unit 372 may store every kind of information used by the device control unit 364 to generate an instruction.

In the present embodiment, the expectation history storage unit 374 stores an expected value of the power supply/demand of the customer facility 112. For example, the expectation history storage unit 374 stores an expected value of the power demand of the customer facility 112. The expectation history storage unit 374 may store an expected value of the power supply of the customer facility 112. The expectation history storage unit 374 may store an expected value of at least one of the remaining amount of the stored power and the unoccupied capacity of the customer facility 112. The expectation history storage unit 374 may store an expected value of surplus power of the customer facility 112.

An expected value P₀ of the surplus power of the customer facility 112 in a certain time period is calculated by the following equation (1), with an expected value P₁ of the power demand of the customer facility 112 in the time period, an expected value P₂ of the power supply of the customer facility 112 in the time period, and an expected value P₃ of the remaining amount of the stored power in the time period, for example.

P₀=P₃+P₂−P₁ (equation 1)

In the present embodiment, the performance history storage unit 376 stores every kind of information obtained by the demand monitoring unit 322, the power generation monitoring unit 324, the power storage monitoring unit 326 and the power transmission/reception monitoring unit 328. The performance history storage unit 376 may store every kind of information obtained by the demand monitoring unit 322, the power generation monitoring unit 324, the power storage monitoring unit 326 and the power transmission/reception monitoring unit 328, to be associated with information indicating the related clock time or time period.

[Summary of the Energy Management Equipment 140]

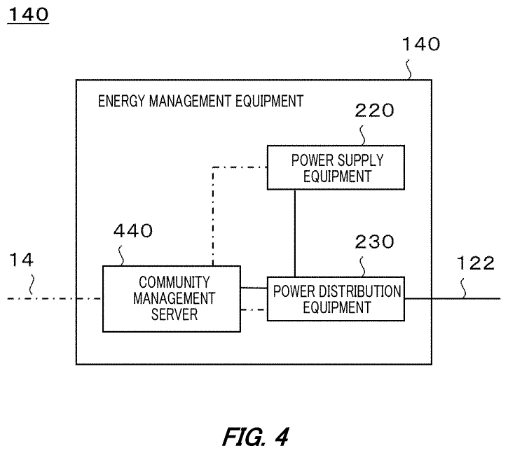

FIG. 4 schematically illustrates an example internal configuration of the energy management equipment 140. In the present embodiment, the energy management equipment 140 includes power supply equipment 220, a power distribution equipment 230, and a community management server 440.

The community management server 440 may be an example of the power interchange apparatus. The community management server 440 may be an example of the condition determination apparatus.

In the present embodiment, the power supply equipment 220 is different from the power supply equipment 220 of the customer facility 112 in that it is operated under the control of the community management server 440. As for the features aside from the difference mentioned above, the power supply equipment 220 of the energy management equipment 140 may have the configuration similar to that of the power supply equipment 220 of the customer facility 112.

In the present embodiment, the power distribution equipment 230 is different from the power distribution equipment 230 of the customer facility 112 in that it controls a power flow between the power transmission/distribution network 122 and each of the power supply equipment 220 and the community management server 440. As for the features aside from the difference mentioned above, the power distribution equipment 230 of the energy management equipment 140 may have the configuration similar to that of the power distribution equipment 230 of the customer facility 112.

[Summary of the Community Management Server 440]

In the present embodiment, the community management server 440 manages energy used in the community 102. For example, the community management server 440 manages power used in the community 102. The community management server 440 manages power supply/demand of the community 102. The community management server 440 may manage power interchange within the community 102. The community management server 440 may manage the power interchange between the community 102 and the other communities.

The community management server 440 performs a process for maintaining the stability and quality of the power which flows over the power transmission/distribution network 122. The community management server 440 performs a process for maintaining the stability and quality of the power which flows over the utility grid power network 12. The community management server 440 may perform a process for maintaining the stability and quality of the power which flows over the utility grid power network 12, in cooperation with the wide area management server 180. The community management server 440 will be described in detail later.

[Specific configuration of each unit of the community management server 440] The community management server 440 may be implemented by hardware, may be implemented by software, or may be implemented by hardware and software. If at least a part of the components which configure the community management server 440 are implemented by software, the components implemented by the software may be implemented by activating a program which stipulates operations related to the components on an information processing apparatus having the general configuration.

The information processing apparatus mentioned above includes, for example: (i) a data processing apparatus including a processor such as a CPU or a GPU, an ROM, an RAM, a communication interface, or other; (ii) an input apparatus such as a keyboard, a touch panel, a camera, a microphone, a sensor of every kind, and a GPS receiver; (iii) an output apparatus such as a display apparatus, a speaker or a vibration apparatus; and (iv) a storage apparatus (including an external storage apparatus) such as a memory or an HDD. In the information processing apparatus mentioned above, the data processing apparatus or the storage apparatus mentioned above may store a program. The program mentioned above may be stored in a non-transitory computer readable recording medium. The program mentioned above is executed by a processor to enable the information processing apparatus mentioned above to perform an operation stipulated by the program. The program mentioned above may be a program for enabling a computer to function as the community management server 440.

In an embodiment, the program mentioned above may be a program for enabling the computer which implements the community management server 440 to perform the power interchange method. The power interchange method mentioned above includes a performance information obtaining step of obtaining, for each of a plurality of first power customers which configure a first community, information about a power interchange performance between the first power customer and the first community, for example. The power interchange method mentioned above includes a contribution degree determination step of determining, for at least one of the plurality of first power customers, a contribution degree of the first power customer to a surplus power amount of the first community in a certain time period, based on the information about the performance obtained in the performance information obtaining step, for example. The power interchange method mentioned above may include a supply/demand information obtaining step of obtaining information about the power supply/demand of each of the plurality of first power customers.

In another embodiment, the program mentioned above may be a program for enabling the computer which implements the community management server 440 to perform the condition determination method. The condition determination method mentioned above may be a method for determining a power interchange condition between: (i) a first user that requires for power interchange in a first time period prior to a second time period under a condition that it provides power in the second time period; and (ii) a second user that can provide power to the first user in the first time period.

The condition determination method mentioned above includes a demand-side condition obtaining step of obtaining: (i) information for identifying the first time period; and (ii) information indicating a first target value related to a power amount provided to the first user from the second user in the first time period, for example. The condition determination method mentioned above includes a supply-side condition obtaining step of obtaining information indicating a condition for providing power by the second user in the first time period, for example. The condition determination method mentioned above includes a return condition determination step of determining at least one of: (i) a second target value related to a power amount provided to the second user from the first user in the second time period, and (ii) a parameter that indicates a relationship between the first target value and the second target value, based on the information obtained in the demand-side condition obtaining step and the information obtained in the supply-side condition obtaining step, for example.

The condition determination method mentioned above may include a second supply/demand expectation obtaining step of obtaining information indicating an expected value of power supply/demand of the second user in the second time period. In the condition determination method mentioned above, the return condition determination step mentioned above may include determining, based on the information obtained in the first supply/demand expectation obtaining step, one or more candidates that relate to time periods included in the second time period, the time periods in which the first user provides power to the second user. In the condition determination method mentioned above, the return condition determination step mentioned above may include determining at least one of the second target value and the parameter, based on an expected value of power supply/demand of the second user in the respective time periods of the one or more candidates indicated by the information obtained in the second supply/demand expectation obtaining step.

The condition determination method mentioned above may also include a second supply/demand expectation obtaining step of obtaining at least one of: (i) information indicating an expected value of power supply/demand of the second user in the first time period; and (ii) information indicating an expected value of power supply/demand of the second user in the second time period. In the condition determination method mentioned above, the return condition determination step mentioned above may also include determining at least one of the second target value and the parameter, based on the information obtained in the demand-side condition obtaining step, the information obtained in the supply-side condition obtaining step, and the information obtained in the second supply/demand expectation obtaining step.

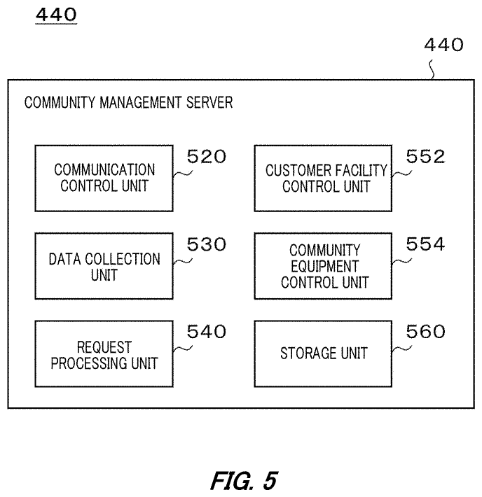

FIG. 5 schematically illustrates an example internal configuration of the community management server 440. In the present embodiment, the community management server 440 includes a communication control unit 520, a data collection unit 530, a request processing unit 540, a customer facility control unit 552, a community equipment control unit 554, and a storage unit 560.

The data collection unit 530 may be an example of the supply/demand information obtaining unit, the performance information obtaining unit, and the expectation information obtaining unit. The request processing unit 540 may be an example of every kind of information obtaining units, the power interchange apparatus, the contribution degree determination unit, the request obtaining unit, the procurement judgement unit, and the interchange amount determination unit.

The data collection unit 530 may be an example of the demand-side condition obtaining unit, the supply-side condition obtaining unit, the first supply/demand expectation obtaining unit, and the second supply/demand expectation obtaining unit. The request processing unit 540 may be an example of the condition determination apparatus the demand-side condition determination unit, the supply-side condition determination unit, and the return condition determination unit.

In the present embodiment, the communication control unit 520 controls communication between the community management server 440 and the other devices. The communication control unit 520 may be a communication interface of every kind. The communication control unit 520 may support one or a plurality of communication systems.

The communication control unit 520 may control communication between the community management server 440 and a device provided within the energy management equipment 140. The communication control unit 520 may control communication between the community management server 440 and the controller 240 provided in each of a plurality of customer facilities which configure the community 102. The communication control unit 520 may control communication between the community management server 440 and at least one of the power transformation equipment 120 and the interchange equipment 160.

The communication control unit 520 may control communication between the community management server 440 of the community 102 and the community management servers 440 of the other communities. The communication control unit 520 may control communication between the community management server 440 and the wide area management server 180.

In the present embodiment, the data collection unit 530 collects every kind of information about the community 102. The data collection unit 530 may collect information stored in the storage unit 370 of the controller 240 provided in each of a plurality of customer facilities which configure the community 102. The data collection unit 530 may store the collected information in the storage unit 560.

In an embodiment, the data collection unit 530 obtains, from the controller 240 provided in each of a plurality of customer facilities which configure the community 102, at least one of: (i) information about a power demand performance of each customer facility; (ii) information about a power supply performance of each customer facility; (iii) information about a performance of the chargeable/dischargeable power amount of the power storage apparatus 224 of each customer facility; and (iv) information about a power transmission/reception performance of each customer facility. The information about the power transmission/reception of each customer facility may include information about a power interchange performance between each customer facility and the community 102.

In another embodiment, the data collection unit 530 may obtain, from the controller 240 provided in each of a plurality of customer facilities which configure the community 102, at least one of: (i) information about an expected value of power demand of each customer facility; (ii) information about an expected value of power supply of each customer facility; (iii) information about an expected value of the chargeable/dischargeable power amount of the power storage apparatus 224 of each customer facility; and (iv) information about an expected value of power transmission/reception between each customer facility and the community 102. The controller 240 of each customer facility may transmit the information to the data collection unit 530, in response to a request from the data collection unit 530 or in a periodic manner.

In yet another embodiment, the data collection unit 530 may obtain, from the power transformation equipment 120, information about a power transmission/reception performance between the utility grid power network 12 and the community 102. The data collection unit 530 may obtain, from the interchange equipment 160, information about a power transmission/reception performance between the community 102 and the community 104. The power transformation equipment 120 or the interchange equipment 160 may transmit the information to the data collection unit 530, in response to a request from the data collection unit 530 or in a periodic manner.

[Summary of the request processing unit 540] In the present embodiment, the request processing unit 540 receives every kind of requests from the other devices. For example, a user of the customer facility 112 operates the customer terminal 250 and performs a process related to power interchange. The customer terminal 250 transmits a request in accordance with an operation of the user mentioned above to the controller 240. The request processing unit 350 of the controller 240 receives the request from the customer terminal 250 and transmits the request to the community management server 440. The request processing unit 350 may refer to the storage unit 370 to extract information required for a process in the community management server 440 and transmit to the community management server 440 the extracted information and the request mentioned above to be associated with each other.

In an embodiment, the request processing unit 540 receives from at least one of the customer facility 112 and the customer facility 114, a request related to power interchange from the community 102 to another community. The request related to power interchange may be referred to as a power interchange request. An arbitrary future clock time or time period may be specified as the time when the power interchange is to be performed. As a power receiving entity, a certain customer facility may be designated or a certain customer facility may not be designated. If a certain customer facility is not designated as a power receiving entity, the interchanged power may be handled at the discretion of the energy management equipment 140 of another community mentioned above.

For example, the request processing unit 540 judges whether the request processing unit 540 can accept the request mentioned above, based on the expected value of the surplus power amount of the community 102 at the time when the power interchange is to be performed. If it is judged that the request processing unit 540 can accept the request mentioned above, the request processing unit 540 generates information for reserving the power interchange at the time the power interchange is to be performed. Information for reserving power interchange in a certain future time period may be referred to as reservation information.

It is noted that a future clock time or time period may include the “present time”. For example, if a clock time or a time period “from now”, “right now”, “as soon as the power interchange request is accepted”, or “as soon as the power interchange is prepared” is specified in the power interchange request as the time when the power interchange is to be performed, the designation refers to a clock time or a time period in a very near future.

A designation method of a future clock time or time period is not particularly limited. As a future clock time or time period, information indicating a certain clock time may be input, information indicating a starting clock time of a certain time period may be input, or information indicating a starting clock time and an ending clock time of a certain time period may be input. Information indicating a starting clock time of a certain time period may be information indicating a certain clock time or may be information indicating a certain event. Information indicating a starting clock time of a certain time period may be information indicating a condition that the power interchange ends up by a certain clock time, or may be information indicating a condition that the power interchange ends up by a starting clock time or an ending clock time of a certain event.

As a future clock time or time period, information indicating a condition that a certain event is detected may be input. The content of an event is not particularly limited. In this case, the request processing unit 540 may include an event detection unit to detect an event (not illustrated in the figure), for example.

In another embodiment, the request processing unit 540 receives from at least one of the customer facility 112 and the customer facility 114, a request related to power interchange, taking as collateral the power to be provided in the future. For example, the request processing unit 540 receives from the customer facility 112, the “power interchange request to request power interchange to the customer facility 112 in a first time period prior to a second time period under a condition that the customer facility 112 provides power in the second time period”.

According to the example mentioned above, the request processing unit 540 judges whether the customer facility 114 can provide power to the customer facility 112 in the first time period. If it is judged that the customer facility 114 can provide power to the customer facility 112 in the first time period, the request processing unit 540 determines a power amount which the customer facility 112 provides to the customer facility 114 in the second time period. In addition, the request processing unit 540 generates reservation information for reserving power interchange from the customer facility 114 to the customer facility 112 in the first time period and reservation information for reserving power interchange from the customer facility 112 to the customer facility 114 in the second time period.

In the present embodiment, the request processing unit 540 creates in advance, for each predetermined time period: (i) a plan related to power transmission/reception between the power transmission/distribution network 122 and each customer facility which configures the community 102; (ii) a plan related to power transmission/reception between the utility grid power network 12 and the power transformation equipment 120; and (iii) a plan related to power transmission/reception between the self supporting line 16 and the interchange equipment 160. For example, the request processing unit 540 creates a plan for power transmission/reception per 30 minutes on the next day, at noon every day. According to the present embodiment, the request processing unit 540 creates the plan mentioned above based on an expected value of the power supply/demand of each customer facility and a power interchange amount indicated by the reservation information. In the present embodiment, the request processing unit 540 monitors the power transmission/reception performance and adjusts the supply/demand of each customer facility such that the power transmission/reception is performed in accordance with the plan mentioned above.

In the present embodiment, the request processing unit 540 settles demand and supply of power for each of a plurality of customer facilities which configure the community 102 (which may be referred to as a settlement process). For example, the request processing unit 540 calculates a power bill for each of a plurality of customer facilities which configure the community 102. The request processing unit 540 may calculate the power bill for each time period predetermined based on the history of the power transmission/reception performance between each customer facility and the community 102 (which may be referred to as a settlement time period). The request processing unit 540 may also perform an offset process on the power interchange amount with the outside in the predetermined time period for each of a plurality of customer facilities which configure the community 102. The request processing unit 540 will be described in detail later.

In the present embodiment, the customer facility control unit 552 generates an instruction for controlling each of a plurality of customer facilities managed by the community management server 440. The customer facility control unit 552 transmits the generated instruction to the customer facility subject to the instruction. This allows the community management server 440 to control each customer facility.

In the present embodiment, the community equipment control unit 554 generates an instruction for controlling at least one of the power supply equipment 220 and the power distribution equipment 230 provided in the energy management equipment 140. The customer facility control unit 552 transmits the generated instruction to the equipment subject to the instruction. This allows the community management server 440 to control the power transmission/reception of the energy management equipment 140.

In the present embodiment, the community management server 440 includes the storage unit 560. The storage unit 560 stores every kind of information required for information processing in each unit of the community management server 440. The storage unit 560 may store every kind of information generated by each unit of the community management server 440. The storage unit 560 will be described in detail later.

### Specific Example 1 of the Process by the Request Processing Unit 540

For example, the following case is taken into consideration: a user of the customer facility 112 of the community 102 participates in an event held in the customer facility which configures the community 104. During the event period and the transit period of the user, the power demand of the customer facility where the event is held (which may be referred to as an event venue) increases, while the power demand of the customer facility 112 decreases. In addition, if the user of the customer facility 112 moves to the event venue by use of the electric vehicle 22, or if the user of the customer facility 112 carries the portable storage battery 24 to the event venue, the remaining amount of the stored power and the unoccupied capacity of the event venue increase, while the remaining amount of the stored power and the unoccupied capacity of the customer facility 112 decrease.

As the number of participants in the event increases, it may be difficult to maintain a balance of the power supply/demand in the community 104. In addition, it may cost much to purchase power from the utility grid power network 12 in order to maintain a balance of the power supply/demand in the community 104. Even in this case, the energy management system 100 according to the present embodiment can adjust the power supply/demand between the community 102 and the community 104 such that power is interchanged from the community 102 to the community 104 in the event period.

Specifically, at a proper time before the user of the customer facility 112 of the community 102 participates in the event, the customer terminal 250 is operated to perform a process for interchanging power from the community 102 to the community 104 in an arbitrary time period during the event period and the transit period of the user. The community management server 440 of the community 102 receives a power interchange request from the user and generates reservation information which corresponds to the power interchange request. In addition, the community management server 440 of the community 102 transmits the generated reservation information to the community management server 440 of the community 104. The community management server 440 of the community 102 and the community management server 440 of the community 104 determine a specific time when power is to be interchanged and the power transmission/reception amount at the time.

The community management server 440 of the community 102 and the community management server 440 of the community 104 create a power transmission/reception plan for each unit time period, taking into account the reservation information. This facilitates adjustment of the power supply/demand in the community 104 during the event period.

In addition, the community management server 440 of the community 102 determines a power bill to be paid to the customer facility 112 of the community 102 by subtracting a power amount indicated by the reservation information from the power amount transmitted by the customer facility 112 of the community 102 to the power transmission/distribution network 122 of the community 102. The power bill charged to the event venue is determined by subtracting the power amount indicated by the reservation information from the power amount received by the event venue from the power transmission/distribution network 122 of the community 104. This reduces the power bill to be paid by the event venue.

Furthermore, according to the present embodiment, the electric vehicle 22 and the portable storage battery 24 of the participant in the event can be handled as a part of a virtual power storage apparatus managed by the community 104. This reduces the burden on the community 104 to arrange a large scale power storage apparatus and increase the remaining amount of the stored power of the community 104 in advance in preparation for the event.

In an embodiment, the power interchange is performed via the interchange equipment 160 and the self supporting line 16. This allows the power to be interchanged directly between the community 102 and the community 104, not via the utility grid power network 12. In this case, the power interchange may be realized as a process on data on the community management server 440 of the community 102 and the community management server 440 of the community 104.

In another embodiment, the power interchange may be realized as a process on data on the wide area management server 180. Specifically, a value obtained by subtracting the “power amount supplied from the community 102 to the utility grid power network 12 in the time period in accordance with the instruction of the user of the customer facility 112” from the “power amount actually supplied from the utility grid power network 12 to the community 104 during the event period” is treated as the “power amount supplied from the utility grid power network 12 to the community 104 during the event period”. This allows the community 102 and the community 104 to indirectly interchange the power via the utility grid power network 12.

### Specific Example 2 of the Process by the Request Processing Unit 540

For example, the following case is taken into consideration: a user of the customer facility 112 of the community 102 charges at least one of the electric vehicle 22 and the portable storage battery 24, by use of a charging station provided in the customer facility which configures the community 104. The user of the customer facility 112 of the community 102 may be an owner or a user of at least one of the electric vehicle 22 and the portable storage battery 24. According to the energy management system 100 according to the present embodiment, the user of the customer facility 112 of the community 102 can interchange power from an owner, a manager or an operator of the charging station provided in the community 104, taking as collateral the power to be provided in the future.

For example, the user of the customer facility 112 of the community 102 transmits, under a condition that the customer facility 112 provides power to the community 104 in a second time period, a power interchange request to the energy management equipment 140 of the community 102 to request to interchange power from the charging station of the community 104 to the electric vehicle 22 or the portable storage battery 24 of the customer facility 112 in a first time period prior to the second time period. The user of the customer facility 112 of the community 102 transmits the power interchange request mentioned above to the energy management equipment 140 of the community 102, by use of: (i) a mobile terminal which functions as the customer terminal 250 of the customer facility 112 of the community 102 as well; or (ii) a customer terminal provided in the charging station of the community 104, for example.

For example, the energy management equipment 140 of the community 102 inquires to the energy management equipment 140 of the community 104 as to whether the charging station of the community 104 can supply power to the user mentioned above in the first time period. If the charging station of the community 104 can supply power to the user mentioned above in the first time period, the energy management equipment 140 of the community 102 determines a power amount to be supplied from the user mentioned above to the charging station of the community 104 in the second time period. The power amount to be supplied from the user mentioned above to the charging station of the community 104 in the second time period may be larger than the power amount supplied from the charging station of the community 104 to the user mentioned above in the first time period. This allows the user of the customer facility 112 of the community 102 to charge at least one of the electric vehicle 22 and the portable storage battery 24 at the charging station provided in the customer facility which configures the community 104, without paying the power bill for charging.

[Summary of Each Unit of the Request Processing Unit 540]

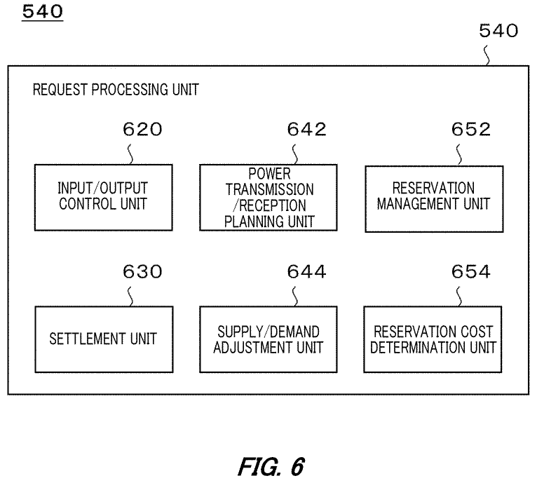

FIG. 6 schematically illustrates an example internal configuration of the request processing unit 540. In the present embodiment, the request processing unit 540 includes an input/output control unit 620, a settlement unit 630, a power transmission/reception planning unit 642, a supply/demand adjustment unit 644, a reservation management unit 652, and a reservation cost determination unit 654.

The reservation management unit 652 may be an example of the power interchange apparatus, every kind of information obtaining units, the contribution degree determination unit, the request obtaining unit, the procurement judgement unit, and the interchange amount determination unit. The reservation cost determination unit 654 may be an example of the condition determination apparatus the demand-side condition determination unit, the supply-side condition determination unit, and the return condition determination unit.

In the present embodiment, the input/output control unit 620 controls an input/output of the request processing unit 540. In an embodiment, the input/output control unit 620 receives a request from each unit of the community 102. The input/output control unit 620 may receive a request from the energy management equipment of the other communities. The input/output control unit 620 may receive a request from the wide area management server 180. In another embodiment, the input/output control unit 620 outputs an instruction to each unit of the community 102. The input/output control unit 620 may output a request to the energy management equipment of the other communities. The input/output control unit 620 may output a request to the wide area management server 180.

In the present embodiment, the input/output control unit 620 may generate data of a display which is displayed on the customer terminal 250 of each customer facility. The display mentioned above may function as an interface between a user of each customer facility and the community management server 440. The input/output control unit 620 may generate data of at least a part of the display for transmitting the power interchange request from the customer terminal 250 of each customer facility to the community management server 440 and transmit the data to the customer terminal 250.

In the present embodiment, the settlement unit 630 settles, for each of a plurality of customer facilities which configure the community 102, the power transmission/reception between the customer facility and the community 102. The settlement unit 630 may also settle, for each of a plurality of customer facilities which configure the community 102, the power interchange between the customer facility and another customer facility.

For example, the settlement unit 630 sums up, for each of a plurality of customer facilities which configure the community 102, the power transmission amount and the power reception amount between the customer facility and another customer facility per settlement time period. The settlement unit 630 may sum up, for each of a plurality of customer facilities which configure the community 102, the revenue and expenditure related to the power per settlement time period.

In the present embodiment, the settlement unit 630 may sum up, for each of a plurality of customer facilities which configure the community 102, the power transmission amount and the power reception amount between the customer facility and another customer facility per unit time period included in the settlement time period. For example, the request processing unit 540 manages, for each of a plurality of customer facilities, a power transmission amount per unit time period such that a sold power amount to the utility grid power network 12 or the energy management equipment 140 and an interchange amount to the other customer facilities are distinguished from each other. This allows the settlement unit 630 to sum up the power transmission amount per unit time period such that the sold power amount to the utility grid power network 12 or the energy management equipment 140 and the interchange amount to the other customer facilities are distinguished from each other.

Similarly, the request processing unit 540 may manage, for each of a plurality of customer facilities, a power reception amount per unit time period such that a purchased power amount from the utility grid power network 12 or the energy management equipment 140 and an interchange amount from the other customer facilities are distinguished from each other. This allows the settlement unit 630 to sum up the power reception amount per unit time period such that the purchased power amount from the utility grid power network 12 or the energy management equipment 140 and an interchange amount from the other customer facilities are distinguished from each other.

The unit prices of power in power purchase and power selling may be determined for each unit time period. The unit prices of power in power purchase and power selling are determined based on the time zone, the season, a type of power generation, or other, for example. On the other hand, power may be interchanged for free of charge in power interchange between one customer facility and the other customer facilities. Power may also be interchanged with charge in the power interchange mentioned above. In the power interchange mentioned above, the unit prices of power in power purchase and power selling may be different from each other. The energy management equipment 140 may collect a commission in power interchange between one customer facility and the other customer facilities. The commission may be given as a monetary value, an electronic value or a proprietary value, or may be given as a power amount.

According to the present embodiment, the settlement unit 630 can sum up the revenue and expenditure of each customer facility in the settlement time period, based on information indicating a summary value of the power transmission amount and the power reception amount of each customer facility per unit time period and information indicating the unit price or the commission, for example. This allows a reservation process related to power transmission/reception generated in response to reception of the power interchange request to be realized as a process on data on one or a plurality of community management servers 440.

For example, the following case is taken into consideration: in response to a power interchange request from the customer facility 112 of the community 102, a reservation is made to transmit power from the customer facility 112 of the community 102 to the customer facility 114 of the community 104 in a unit time period Pi. In this case, the community management server 440 of the community 102 determines a power bill to be paid to the customer facility 112 of the community 102 by subtracting a power amount indicated by the reservation information mentioned above, from the power amount transmitted by the customer facility 112 of the community 102 to the power transmission/distribution network 122 of the community 102 in the unit time period Pi.

On the other hand, the community management server 440 of the community 104 determines a power bill charged to the customer facility 114 of the community 104 by subtracting a power amount indicated by the reservation information mentioned above, from the power amount received by the customer facility 114 of the community 104 from the power transmission/distribution network 122 of the community 104 in the unit time period Pi. This allows every kind of reservation processes related to the power transmission/reception to be realized as a process on data.

In the present embodiment, the power transmission/reception planning unit 642 plans power transmission/reception between each unit of the community 102 and the community 102. The power transmission/reception planning unit 642 may plan power transmission/reception between the community 102 and the utility grid power network 12. The power transmission/reception planning unit 642 may plan power transmission/reception between the community 102 and the self supporting line 16.

For example, the power transmission/reception planning unit 642 generates information including information indicating a time period when the power transmission/reception is performed, information indicating the power transmission side, information indicating the power receiving side, and a power transmission/reception amount, which are associated with one another. The power transmission/reception planning unit 642 may plan the power transmission/reception mentioned above for each unit time period. The power transmission/reception planning unit 642 may plan the power transmission/reception mentioned above based on an expected value of the power supply/demand and the reservation information generated based on the power interchange request.

In the present embodiment, the supply/demand adjustment unit 644 adjusts the power demand and the power supply of the community 102. The supply/demand adjustment unit 644 may also adjust the power transmission/reception between the community 102 and the utility grid power network 12. The supply/demand adjustment unit 644 may also adjust the power transmission/reception between the community 102 and the other communities.

For example, the supply/demand adjustment unit 644 monitors the power demand and the power supply of the community 102 and controls: (i) the power supply equipment 220 of the energy management equipment 140; and (ii) the power supply equipment 220 of each customer facility, to adjust excess or deficiency of power. The supply/demand adjustment unit 644 may control each device provided within the community 102 based on the plan created by the power transmission/reception planning unit 642, for example. For example, the supply/demand adjustment unit 644 controls the power supply/demand of at least one of each customer facility and the power supply equipment 220 of the energy management equipment 140, based on a planned value of the power supply/demand of the community 102 per unit time period and a performance value of the power supply/demand in the unit time period.

If the difference between the performance value and the planned value of the power demand of the customer facility 112 meets a predetermined condition, the supply/demand adjustment unit 644 may request the controller 240 of the customer facility 112 to control the power demand amount in accordance with the plan. If the difference between the performance value and the planned value of the power supply of the customer facility 112 meets a predetermined condition, the supply/demand adjustment unit 644 may request the controller 240 of the customer facility 112 to control the power supply amount in accordance with the plan. If the difference between the performance value and the planned value of the power transmission/reception amount between the customer facility 112 and the power transmission/distribution network 122 meets a predetermined condition, the supply/demand adjustment unit 644 may request the controller 240 of the customer facility 112 to control the power transmission/reception in accordance with the plan.

The predetermined condition in these examples is required to be a condition that the supply/demand adjustment unit 644 can detect an anomalous performance value, and not particularly limited for details. Examples of the predetermined condition can include: (i) a condition that an absolute value of the difference between the performance value and the planned value exceeds a predetermined threshold; (ii) a condition that a ratio of an absolute value of the difference between the performance value and the planned value to the planned value exceeds a predetermined threshold; (iii) a condition that a ratio of the performance value to the planned value does not fall within a predetermined numerical value range, or other.

The supply/demand adjustment unit 644 may adjust the power supply/demand of the community 102 in response to a request from the wide area management server 180. The request from the wide area management server 180 may request to adjust the power demand of the community 102 in accordance with the plan, may request to adjust the power supply of the community 102 in accordance with the plan, may request to decrease or increase the power demand of the community 102 based on a comparison with the plan, or may request to decrease or increase the power supply of the community 102 based on a comparison with the plan.

[Summary of the Reservation Management Unit 652]

In the present embodiment, the reservation management unit 652 generates reservation information which corresponds to the power interchange request, based on the power interchange request from each customer facility of the community 102. The reservation management unit 652 manages a change, deletion, and execution of the reservation.

In the present embodiment, for the sake of simplicity of the description, the reservation management unit 652 will be described in detail, taking as an example the case where the reservation management unit 652 processes a request from the customer facility 112 of the community 102. However, the reservation management unit 652 is not limited to the present embodiment. The reservation management unit 652 can also process a request from the customer facility 114, similarly to a request from the customer facility 112.

[Process for Interchanging a Surplus Power of One Community to the Other Communities]

In the present embodiment, the reservation management unit 652 receives a power interchange request from the customer facility 112 to request to interchange power from the community 102 to the community 104. The power interchange request includes information indicating that the customer facility 112 requests to interchange at least a part of a surplus power of the community 102 to one or a plurality of communities 104 in a certain future time period.

The power interchange request may also include information indicating that two or more customer facilities which configure the community 102 request to interchange at least a part of a surplus power of the community 102 to one or a plurality of communities 104 in a certain future time period. In this case, one of the two or more customer facilities may transmit a single power interchange request as a representative of the two or more customer facilities. The power interchange request may be an example of the interchange request.

In the present embodiment, the power interchange request may include information indicating a condition with respect to the power interchange, required by a customer facility which transmits the request. Examples of the condition mentioned above can include a condition related to a required power for interchange, a condition related to a required time period for interchange, a condition related to a power receiving entity, or other.

Examples of the condition related to a required power for interchange can include a condition related to a quality of the interchanged power, a condition related to a target value of the power amount to be interchanged from the community 102 to the community 104, or other. Examples of the condition related to a quality of power can include information for specifying a voltage of the interchanged power, information for specifying a frequency of the interchanged power, information for specifying an acceptable amount of voltage fluctuations of the interchanged power, or other.

Examples of the condition related to a required time period for interchange can include information for specifying a starting clock time of the power interchange, information for specifying an ending clock time of the power interchange, information for specifying a starting clock time and an ending clock time of the power interchange, information for specifying an available time period for the power interchange, or other. If the power interchange request does not include a condition related to a required time period for interchange, an arbitrary time period on or after the moment when the power interchange request is received may be set as the required time period for interchange.

Examples of the condition related to a power receiving entity can include information for specifying a power receiving entity. If a certain customer facility of the community 104 is designated as a power receiving entity, the energy management equipment 140 of the community 104 handles power interchanged from the community 102 to the community 104 as the power of the certain customer facility. If the community 104 is designated as a power receiving entity, or if a power receiving entity is not designated, the energy management equipment 140 of the community 104 may handle the power interchanged from the community 102 to the community 104 as power shared by the community 104.

In the present embodiment, the reservation management unit 652 accesses the storage unit 560 when it receives a power interchange request. For example, the reservation management unit 652 refers to the storage unit 560 and obtains, for each of a plurality of customer facilities which configure the community 102, information about the power interchange performance between the customer facility and the community 102. The reservation management unit 652 may refer to the storage unit 560 and also obtain information indicating an expected value of the surplus power amount of the community 102 in the time period indicated by the power interchange request.

In an embodiment, the reservation management unit 652 may also obtain, for each of a plurality of customer facilities which configure the community 102, information indicating an expected value of the power supply/demand in the time period indicated by the power interchange request, and calculate, based on the information, information indicating an expected value of the surplus power amount of the community 102 in the time period indicated by the power interchange request. In another embodiment, if the power interchange request does not include a condition related to the required time period for interchange, the reservation management unit 652 may also obtain, for each of a plurality of customer facilities which configure the community 102, information indicating a latest value of the power supply/demand, and calculate, based on the information, information indicating an expected value of the surplus power amount of the community 102 in the time period indicated by the power interchange request.

In the present embodiment, the reservation management unit 652 determines, for at least one of a plurality of customer facilities which configure the community 102, a contribution degree of the customer facility to the surplus power amount of the community 102 in the time period indicated by the power interchange request, based on the information about the power interchange performance between the customer facility and the community 102. The time period indicated by the power interchange request may be an example certain time period or a future time period.

The reservation management unit 652 may determine, for a customer facility which transmits a power interchange request, the contribution degree of the customer facility to the surplus power amount of the community 102 in the time period indicated by the power interchange request. More specifically, the reservation management unit 652 determines the contribution degree of the customer facility 112 to the surplus power amount of the community 102 in the time period indicated by the power interchange request, based on the information about the power interchange performance between the customer facility 112 and the community 102. The contribution degree may be represented by numerical values in series or may be represented by stepwise segments. The respective segments may be distinguished from one another with symbols or characters, or may be distinguished from one another with numerals.

The contribution degree of the customer facility 112 is determined based on at least one of: (i) a power amount interchanged from the customer facility 112 to the community 102 between a reference clock time and either one of a beginning or an end of the time period indicated by the power interchange request; (ii) a ratio of a power amount Aᵢ to a power amount B (Aᵢ/B), where Ai is the power amount interchanged from the customer facility 112 to the community 102, and B is the power amount interchanged from all of the customer facilities which configure the community 102 to the community 102 between a reference clock time and either one of a beginning or an end of the time period indicated by the power interchange request; (iii) the number of times the customer facility 112 interchanges power to the community 102 between a reference clock time and either one of a beginning or an end of the time period indicated by the power interchange request; and (iv) the number of times the customer facility 112 accepts demand response from the community 102 between a reference clock time and either one of a beginning or an end of the time period indicated by the power interchange request, for example. The reference clock time may be an arbitrary clock time before the time period indicated by the power interchange request. The time period between the reference clock time and the beginning of the time period indicated by the power interchange request may be set to be an arbitrary value.

The reservation management unit 652 may determine a contribution degree of at least one a plurality of customer facilities which configure the community 102. For example, the reservation management unit 652 determines the contribution degree of a customer facility which requests the power interchange request. The reservation management unit 652 may also determine contribution degrees of all of the customer facilities which configure the community 102.

In an embodiment, the reservation management unit 652 determines the contribution degree of the customer facility 112 to the surplus power amount of the community 102 in the time period indicated by the power interchange request, whenever the power interchange request is received. In another embodiment, the reservation management unit 652 determines, at an arbitrary timing or in a periodic manner, the contribution degree of the customer facility 112 to the surplus power amount of the community 102 at the moment. The reservation management unit 652 may determine the latest value related to the contribution degree mentioned above at the moment when the power interchange request is received, as the contribution degree mentioned above in the time period indicated by the power interchange request.

In yet another embodiment, the reservation management unit 652 determines an expected value of the contribution degree mentioned above based on the past performance data related to the contribution degree mentioned above, at an arbitrary timing or in a periodic manner. The reservation management unit 652 may determine the contribution degree mentioned above in the time period indicated by the power interchange request, by use of an expected value of the contribution degree mentioned above at the moment when the power interchange request is received.

In the present embodiment, the reservation management unit 652 determines the power amount to be interchanged from the community 102 to the community 104 in the time period indicated by the power interchange request, based on: (i) an expected value of the surplus power amount of the community 102 in the time period indicated by the power interchange request; and (ii) a contribution degree of the customer facility to the surplus power amount of the community 102 in the time period indicated by the power interchange request. For example, the reservation management unit 652 determines the power amount to be interchanged from the community 102 to the community 104 in response to the power interchange request from the customer facility 112, by multiplying (i) an expected value of the surplus power amount of the community 102 in the time period indicated by the power interchange request, by (ii) a contribution degree of the customer facility 112 to the surplus power amount of the community 102 in the time period indicated by the power interchange request.

If the power amount determined in the procedure mentioned above is equal to or greater than the required power amount for interchange indicated by the power interchange request, the reservation management unit 652 generates reservation information for interchanging the power from the community 102 to the community 104 in the time period indicated by the power interchange request. The reservation management unit 652 stores the generated reservation information in the storage unit 560. The reservation information stored in the storage unit 560 is referred to by the power transmission/reception planning unit 642 when it creates the power transmission/reception plan per unit time period. This allows the community management server 440 to interchange power in accordance with the power interchange request from the customer facility 112.

On the other hand, if the power amount determined in the procedure mentioned above is smaller than the required power amount for interchange indicated by the power interchange request, the reservation management unit 652 determines whether the customer facility 112 can interchange power from the other devices in the time period indicated by the power interchange request. For example, the reservation management unit 652 determines whether the customer facility 112 can interchange the power from at least one of the other customer facilities of the community 102 and the energy management equipment 140 of the community 102. This can reduce the power loss in the power transmission/reception. It is noted that the reservation management unit 652 may also determine whether the customer facility 112 can interchange power from the community 104 or the community 106.

For example, the reservation management unit 652 performs a process for interchanging from the community 102 to the community 104, at least a part of a contribution of at least one of the customer facility 114 and the energy management equipment 140 to the surplus power amount of the community 102 in the time period indicated by the power interchange request, in response to the power interchange request from the customer facility 112. The customer facility 114 and the energy management equipment 140 may be an example of the other devices.

In an embodiment, the reservation management unit 652 performs a process for interchanging the power from the community 102 to the community 104, taking as collateral the power to be provided in the future by the customer facility 112. In another embodiment, the reservation management unit 652 performs a process for interchanging power from the community 102 to the community 104, in response to the user of the customer facility 112 agreeing with payment of an additional monetary value, an electronic value or a proprietary value.

For example, if a plurality of power storage apparatuses provided in each of a plurality of customer facilities which configure the community are treated as a part of a virtual power storage apparatus managed by the community, a user of each customer facility may not be allowed to use, monetize or dispose the power as he/she likes, even if it is stored in the owned power storage apparatus. According to the present embodiment, each member can use, monetize or dispose at least a part of the remaining amount of the stored power of the virtual power storage apparatus managed by the community based on his/her own will, even if members of the community cannot use, monetize or dispose the surplus power of the community as they like.

According to the present embodiment, the user of each customer facility can interchange at least a part of the remaining amount of the stored power of the virtual power storage apparatus managed by the community to another community based on his/her own will in an arbitrary future time period. In addition, according to the present embodiment, the user of each customer facility can increase the power amount which can be interchanged to another community based on his/her own will, if the user ensures to provide power to another user in the same community in the future (which may be referred to as power return).

In the present embodiment, the reservation management unit 652 will be described for details, taking as an example the case where a user A of the energy management system 100 ensures to return power to another user B in the same community in the future such that the power of the other user B is supplied to the user A. However, the reservation management unit 652 is not limited to the present embodiment. In another embodiment, a user A of the customer facility may ensure to return power to a manager or an operator of the community in the future such that the power of the community is supplied to the user A.

In yet another embodiment, a user A of the energy management system 100 may ensure to return power to a user D of another community in the future such that the power of the user D is supplied to the user A. In yet another embodiment, a user A of the energy management system 100 may ensure to return power to a manager or an operator of another community in the future such that the power of the other community is supplied to the user A.

[B. Process of interchanging power, taking as collateral the power to be provided in the future] In the present embodiment, the reservation management unit 652 receives from the customer facility 112, the power interchange request to request power interchange to the customer facility 112 in a first time period prior to a second time period under a condition that the customer facility 112 provides power in the second time period. The power interchange request may include information about an incentive to accept the request of the customer facility 112. The power interchange request may also include information about at least one of penalty and compensation which is applied if the customer facility 112 does not provide power in the second time period.

For example, the reservation management unit 652 receives a power interchange request from the customer facility 112, indicating that “the customer facility 112 ensures to provide power of 1.2 kWh from 13:00 to 15:00 tomorrow” and “the customer facility 112 requests to interchange power of 1 kWh within one hour from now”. Here, the clock time “from now” or the time period “within one hour from now” may be an example of the first time period. The time period “from 13:00 to 15:00 tomorrow” may be an example of the second time period. In addition, in the example mentioned above, the required power amount for interchange is 1 kWh and the incentive is 20% of the interchanged power amount.

In an embodiment, the reservation management unit 652 invites a customer facility or energy management equipment which can respond to the power interchange request from the user of the customer facility 112 (which may be referred to as a supply-side apparatus) and matches the customer facility 112 with the supply-side apparatus. In another embodiment, the reservation management unit 652 registers in advance information of the customer facility or the energy management equipment which requires for providing power (which may be referred to as a supply-side apparatus). The information about a supply-side apparatus is stored in the storage unit 560, for example. If the power interchange request is received, the reservation management unit 652 refers to the information registered in advance and matches the customer facility 112 with the supply-side apparatus. The customer facility 112 may be an example of the first user. The supply-side apparatus may be an example of the second user.

Power may be provided from one or a plurality of supply-side apparatuses to the customer facility 112 during the first time period in multiple parts. Similarly, power may also be provided from the customer facility 112 to one or a plurality of supply-side apparatuses during the second time period in multiple parts.

If the customer facility 112 is successfully matched with the supply-side apparatus, the reservation management unit 652 generates reservation information which corresponds to the power interchange request mentioned above. For example, the reservation management unit 652 generates: (i) one or more pieces of reservation information for reserving power supply from one or a plurality of supply-side apparatuses to the customer facility 112 in one or a plurality of time periods in the first time period (which may be referred to as a procurement time period); (ii) one or more pieces of reservation information for reserving power supply from the customer facility 112 to one or a plurality of supply-side apparatuses in one or a plurality of time periods in the second time period (which may be referred to as a return time period).

[B-1. Determination of the Demand-Side Condition]

In the present embodiment, the power interchange request may include a condition required by the customer facility 112 with respect to power interchange (which may be referred to as a demand-side condition). Examples of the demand-side condition can include: (i) information for identifying the first time period; (ii) information indicating a first target value related to the power amount provided from the supply-side apparatus to the customer facility 112 in the first time period, or other. Examples of the information for identifying the first time period can include information indicating a beginning of the first time period, information indicating an end of the first time period, information indicating a beginning and an end of the first time period, or other. The demand-side condition may be an example of the instruction from the customer facility 112.

The demand-side condition may include information about an upper limit value of the power amount provided per unit time period if the customer facility 112 provides power in the second time period. The demand-side condition may also include information about an upper limit value of the number of unit time periods in which the power is provided, from among one or more unit time periods included in the second time period. The information mentioned above may be an example of information indicating an upper limit value of the acceptable number of divisions in the second time period.

In the present embodiment, the reservation management unit 652 may obtain information indicating a history of power interchange performance of the customer facility 112 when it receives the power interchange request. Examples of the information indicating a history of power interchange performance can include information about the power transmission/reception of the customer facility 112. The starting time and the ending time of the history may be set in an arbitrary manner.

The reservation management unit 652 may determine a cooperation degree related to the power interchange of the customer facility 112, based on the information indicating the history of the power interchange performance of the customer facility 112. The cooperation degree may be represented by numerical values in series or may be represented by stepwise segments. The respective segments may be distinguished from one another with symbols or characters, or may be distinguished from one another with numerals. Examples of the cooperation degree can include: (i) the number of times the customer facility 112 interchanges power to the community 102 in a certain time period; (ii) the interchanged power amount from the customer facility 112 to the community 102 in a certain time period; and (iii) a parameter calculated based on at least one of the number of times and the power amount, or other.

The reservation management unit 652 may determine one or more time periods suitable for the power interchange in the first time period, based on the information indicating the history of the power interchange performance of the customer facility 112. This allows for an efficient power interchange. In addition, this also allows the reservation management unit 652 to provide different incentives to the supply-side apparatus, depending on whether it provides power in at least a part of one or more time periods suitable for the power interchange or in the other time periods. This facilitates matching of the customer facility 112 and the supply-side apparatus.

In an embodiment, the reservation management unit 652 calculates a probability that the power interchange of the customer facility 112 succeeds in the first time period, based on information indicating the history of the power interchange performance of the customer facility 112. For example, the reservation management unit 652 calculates, for each of unit time periods included in the first time period, a probability that the power interchange of the customer facility 112 succeeds in the first time period, based on information indicating the history of the power interchange performance of the customer facility 112. The reservation management unit 652 may calculate, for each of unit time periods included in the first time period, a probability the power interchange of the customer facility 112 succeeds, based on information indicating the history of the power interchange performance of the customer facility 112 and weather information related to the first time period.

The reservation management unit 652 may determine, as one or more time periods suitable for the power interchange, a time period in the first time period when the probability that the power interchange of the customer facility 112 succeeds satisfies a predetermined condition. The reservation management unit 652 may also determine a threshold such that a ratio (AB) satisfies the predetermined condition, where (A) is a time period when the probability that the power interchange of the customer facility 112 succeeds exceeds the threshold and (B) is a time period when the probability that the power interchange of the customer facility 112 succeeds falls below the threshold. Examples of the predetermined condition can include: a condition that the ratio mentioned above is equal to a predetermined value; a condition that the ratio mentioned above is smaller than a predetermined value; a condition that the ratio mentioned above is larger than a predetermined value, or other.

In another embodiment, the reservation management unit 652 inputs information for identifying the first time period in a learning machine which has learned the power interchange performance of the customer facility 112 and obtains information indicating one or more time periods suitable for the power interchange. The reservation management unit 652 may also input information for identifying the first time period in a learning machine which has learned the power interchange performance of the customer facility 112 and weather information related to the first time period, and obtain information indicating one or more time periods suitable for the power interchange.

In the present embodiment, the following case will be described: the reservation management unit 652 obtains information indicating the power interchange performance of the customer facility 112 and determines one or more time periods suitable for the power interchange, from among the first time period. However, the reservation management unit 652 is not limited to the present embodiment. In another embodiment, the reservation management unit 652 may obtain an expected value of the power interchange performance of the customer facility 112 and determine one or more time periods suitable for the power interchange, from among the first time period. The reservation management unit 652 may obtain a performance value or an expected value of the power supply/demand of the customer facility 112 and determine one or more time periods suitable for the power interchange, from among the first time period.

[B-2. Determination of the supply-side condition] In the present embodiment, when the reservation management unit 652 receives the power interchange request, it obtains information indicating a condition that the supply side provides power in the first time period (which may be referred to as a supply-side condition). The supply-side condition may be an example of the instruction from the supply-side apparatus. The supply-side condition may include at least one of: (i) information for identifying one or a plurality of time periods when the supply-side apparatus can provide power; (ii) information indicating a quality of power which the supply-side apparatus can provide in each time period mentioned above; and (iii) information indicating a power amount which the supply-side apparatus can provide in each time period mentioned above.

The supply-side condition may include a condition related to power the customer facility 112 provides to the supply-side apparatus in the second time period. The condition mentioned above may include at least one of: (i) information indicating an upper limit value of the power amount provided per unit time period if the power is provided in the second time period; and (ii) information indicating an upper limit value of the number of unit time periods when the power is provided, from among one or more unit time periods included in the second time period. The information mentioned above may be an example of information indicating an upper limit value of the acceptable number of divisions in the second time period.

In the present embodiment, the reservation management unit 652 may obtain information indicating a history of power interchange performance of the supply-side apparatus when it receives the power interchange request. Examples of the information indicating a history of power interchange performance can include information about the power transmission/reception of each supply-side apparatus. The starting time and the ending time of the history may be set in an arbitrary manner.

The reservation management unit 652 may determine a cooperation degree related to the power interchange of each supply-side apparatus, based on the information indicating the history of the power interchange performance of each supply-side apparatus. The cooperation degree may be represented by numerical values in series or may be represented by stepwise segments. The respective segments may be distinguished from one another with symbols or characters, or may be distinguished from one another with numerals. Examples of the cooperation degree can include: (i) the number of times each supply-side apparatus interchanges power to the community in a certain time period; (ii) the interchanged power amount from each supply-side apparatus to the community in a certain time period; and (iii) a parameter calculated based on at least one of the number of times and the power amount, or other.

In an embodiment, the reservation management unit 652 invites a customer facility or energy management equipment which can respond to the power interchange request from the user of the customer facility 112. The supply side transmits a supply-side condition to the reservation management unit 652 when it applies for the invitation. This allows the reservation management unit 652 to obtain the supply-side condition. In another embodiment, the supply-side apparatus which requires for providing power to others accesses the community management server 440 and registers the supply-side condition in advance. The reservation management unit 652 refers to the storage unit 560 and obtains the supply-side condition registered by the supply-side apparatus in advance.

[B-3. Determination of the return power amount or the interest rate parameter] The reservation management unit 652 determines, based on at least one of the demand-side condition and the supply-side condition, at least one of: (i) a second target value related to a power amount provided from the customer facility 112 to the supply-side apparatus in the second time period; and (ii) a parameter which indicates relationship between the first target value and the second target value. Examples of the parameter mentioned above can include a ratio of the first target value (A) to the second target value (B) (A/B), a ratio of a difference between the second target value and the first target value to the first target value ((B-A)/A), or other.

The first target value corresponds to a principal in a monetary loan, for example. The difference between the second target value and the first target value corresponds to an amount of interests in a monetary loan, for example. The parameter which indicates the relationship between the first target value and the second target value corresponds to an interest rate in a monetary loan, for example. Therefore, the first target value may be referred to as a procured power amount in the present specification. The second target value may be referred to as a return power amount. In addition, the parameter which indicates the relationship between the first target value and the second target value may be referred to as an interest rate parameter.

In the present embodiment, the reservation management unit 652 transmits to the reservation cost determination unit 654, information indicating at least one of the demand-side condition and the supply-side condition. The reservation cost determination unit 654 outputs, based on information indicating at least one of the demand-side condition and the supply-side condition, information indicating at least one of the return power amount and the interest rate parameter. The reservation management unit 652 obtains information indicating at least one of the return power amount and the interest rate parameter output by the reservation cost determination unit 654. This determines at least one of the return power amount and the interest rate parameter.

[B-4. Matching]

In an embodiment, the reservation management unit 652 invite, for each of one or more unit time periods included in the second time period, one or more supply-side apparatuses which require for power supply to the customer facility 112 in the determined return power amount or at the determined interest rate. In another embodiment, the reservation management unit 652 extracts one or more supply-side apparatuses which require for power supply to the customer facility 112 in the determined return power amount or at the determined interest rate, from one or more supply-side apparatuses registered in advance.

The reservation management unit 652 may determine, based on an arbitrary reference, one or more supply-side apparatuses which provide power to the customer facility 112, from among one or more supply-side apparatuses which respond to the invitation or one or more extracted supply-side apparatuses. For example, the reservation management unit 652 determines one or more supply-side apparatuses which provide power to the customer facility 112 from the other devices of the community 102 to which the customer facility 112 belongs. This reduces the power loss in the power transmission. The reservation management unit 652 may determine one or more supply-side apparatuses which provide power to the customer facility 112 such that the number of one or more supply-side apparatuses to provide power to the customer facility 112 is decreased. This can decrease the number of times the power is transmitted/received. As a result, the power loss in the power transmission/reception is reduced.

[Summary of the Reservation Cost Determination Unit 654]

In the present embodiment, the reservation cost determination unit 654 determines a cost required for reserving power interchange in a certain future time period. The reservation cost determination unit 654 may determine a cost type and a cost amount. Examples of the cost type can include a monetary value, an electronic value, a proprietary value, a power amount, or other. Examples of the monetary value can include currency, money, or other. Examples of the electronic value can include points, mileage points, electronic money, or other. Examples of the proprietary value can include cryptocurrency. It is noted that the cryptocurrency may be treated as a monetary value.

If the power amount is specified as the cost type of reservation, the reservation cost determination unit 654 determines at least one of a return power amount and an interest rate parameter. The reservation cost determination unit 654 may determine, based on at least one of the demand-side condition and the supply-side condition, information indicating at least one of the return power amount and the interest rate parameter. The reservation cost determination unit 654 obtains information indicating at least one of the demand-side condition and the supply-side condition from the reservation management unit 652, for example.

In an embodiment, at least one of the return power amount and the interest rate parameter is specified in at least one of the demand-side condition and the supply-side condition. The reservation cost determination unit 654 may determine, as specified in at least one of the demand-side condition and the supply-side condition, information indicating at least one of the return power amount and the interest rate parameter.

For example, the demand-side condition included in the power interchange request includes information indicating at least one of the return power amount and the interest rate parameter. When the reservation management unit 652 invites a supply-side apparatus which can respond to a power interchange request from the customer facility 112, at least one of the return power amount and the interest rate parameter required by the customer facility 112 may be specified in the invitation notice, and at least one of the return power amount and the interest rate parameter required by the supply-side apparatus may be specified in the response from the supply-side apparatus to the invitation. When the supply-side apparatus registers information about the apparatus in advance, information about at least one of the return power amount and the interest rate parameter required by the supply-side apparatus may be registered.

In another embodiment, the reservation cost determination unit 654 determines at least one of the return power amount and the interest rate parameter based on: (i) information for identifying the first time period and the second time period included in the demand-side condition; (ii) at least one of the power supply/demand of the customer facility 112 in the first time period, the power supply/demand of each supply-side apparatus in the first time period, the power supply/demand of the customer facility 112 in the second time period, the power supply/demand of each supply-side apparatus in the second time period, a return performance of the customer facility 112, and a return performance of each supply-side apparatus. At least one of the return power amount and the interest rate parameter may be determined to meet the condition specified by the customer facility 112. At least one of the return power amount and the interest rate parameter may be determined to meet the condition specified by the supply-side apparatus.

In the present embodiment, the reservation cost determination unit 654 may obtain at least one of: (i) information indicating an expected value of the power supply/demand of the customer facility 112 in the first time period; and (ii) information indicating an expected value of the power supply/demand of the customer facility 112 in the second time period. The reservation cost determination unit 654 may also obtain information about the power supply/demand of the customer facility 112 in a time period before the beginning of the first time period.

In the present embodiment, the reservation cost determination unit 654 may obtain at least one of: (i) information indicating an expected value of the power supply/demand of the supply-side apparatus in the first time period; and (ii) information indicating an expected value of the power supply/demand of the supply-side apparatus in the second time period. The reservation cost determination unit 654 may also obtain information about the power supply/demand of the supply-side apparatus in a time period before the beginning of the first time period.

In the present embodiment, the reservation cost determination unit 654 may obtain information about the return performance of the customer facility 112 in a time period before the beginning of the first time period. The reservation cost determination unit 654 may obtain information about the return performance of the customer facility 112, based on information about the power interchange performance between the customer facility 112 and the community 102.

In the present embodiment, the reservation cost determination unit 654 may obtain information about the return performance of each supply-side apparatus in a time period before the beginning of the first time period. The reservation cost determination unit 654 may obtain information about the return performance of each supply-side apparatus, based on information about the power interchange performance between each supply-side apparatus and the community.

For example, at least one of the return power amount and the interest rate parameter is determined such that the return power amount will be larger as the surplus power amount of the customer facility 112 is smaller in the first time period. For example, at least one of the return power amount and the interest rate parameter is determined such that the return power amount will be larger as the surplus power amount of the supply-side apparatus is smaller in the first time period. For example, at least one of the return power amount and the interest rate parameter is determined such that the return power amount will be larger as the surplus power amount of the customer facility 112 is larger in the second time period. For example, at least one of the return power amount and the interest rate parameter is determined such that the return power amount will be larger as the surplus power amount of the supply-side apparatus is larger in the second time period. For example, at least one of the return power amount and the interest rate parameter is determined such that the return power amount will be smaller as the return performance of the customer facility 112 is better. At least one of the return power amount and the interest rate parameter is determined such that the return power amount will be larger as the return performance of the customer facility 112 is better.

[Example information processing in the request processing unit 540] [Example of determining the return power amount based on the power supply/demand of the customer facility 112] According to the present embodiment, first, the reservation cost determination unit 654 determines at least one of the return power amount and the interest rate parameter, based on the demand-side condition, the supply-side condition, and an expected value of the power supply/demand of the customer facility 112 in the second time period. Specifically, the reservation cost determination unit 654 identifies the first time period and the second time period based on the demand-side condition. The reservation cost determination unit 654 identifies one or more supply-side apparatuses which can provide power in the first time period, based on the supply-side condition. In the present embodiment, the reservation cost determination unit 654 determines at least one of the return power amount and the interest rate parameter, based on an expected value of the power supply/demand of the customer facility 112 in the second time period.

For example, the reservation cost determination unit 654 calculates, for each unit time period included in the second time period, the surplus power amount of the customer facility 112 based on an expected value of the power supply/demand of the customer facility 112 in the second time period. The reservation cost determination unit 654 determines at least one of the return power amount and the interest rate parameter in the unit time period such that the return power amount will be larger in the unit time period as the surplus power amount of the customer facility 112 is larger in the unit time period.

Then, the reservation management unit 652 invite, for each of one or more unit time periods included in the second time period, one or more supply-side apparatuses which require for power supply to the customer facility 112 in the determined return power amount or at the determined interest rate. The reservation management unit 652 may extract one or more supply-side apparatuses which require for power supply to the customer facility 112 in the determined return power amount or at the determined interest rate, from one or more supply-side apparatuses registered in advance. The reservation management unit 652 determines, based on an arbitrary reference, one or more supply-side apparatuses which provide power to the customer facility 112, from among one or more supply-side apparatuses which respond to the invitation or one or more extracted supply-side apparatuses.

For example, the reservation management unit 652 determines: (i) one or more supply-side apparatuses; and (ii) the return time period and the return power amount from the customer facility 112 to each supply-side apparatus such that: (i) the total power amount which one or more supply-side apparatuses can provide in the first time period exceeds the procured power amount; and (ii) the power amount which the customer facility 112 provides in the second time period is the smallest. This facilitates the power return by the customer facility 112.

The reservation management unit 652 may also determine: (i) one or more supply-side apparatuses; and (ii) the return time period and the return power amount from the customer facility 112 to each supply-side apparatus such that: (i) the total power amount which one or more supply-side apparatuses can provide in the first time period exceeds the procured power amount; and (ii) the number of one or more supply-side apparatuses is as small as possible. This reduces the power loss in the power transmission/reception.

The reservation management unit 652 and the reservation cost determination unit 654 may perform matching with varied lengths of the unit time period to search for a combination which makes the power amount provided by the customer facility 112 in the second time period smaller. The reservation management unit 652 and the reservation cost determination unit 654 may perform matching with varied lengths of the unit time period to search for a combination which makes the number of one or more supply-side apparatuses smaller.

The reservation management unit 652 determines, based on an arbitrary reference, the power amount supplied from each of one or more supply-side apparatuses mentioned above to the customer facility 112 in the first time period. Subsequently, the reservation management unit 652 generates one or more pieces of reservation information related to the first time period and one or more pieces of reservation information related to the second time period.

### Example of Determining the Return Power Amount Based on the Power Supply/Demand of the Supply-Side Apparatus

According to the present embodiment, first, the reservation cost determination unit 654 determines at least one of the return power amount and the interest rate parameter, based on the demand-side condition, the supply-side condition, and an expected value of the power supply/demand of each supply-side apparatus in the second time period. Specifically, the reservation cost determination unit 654 identifies the first time period and the second time period based on the demand-side condition. The reservation cost determination unit 654 identifies one or more supply-side apparatuses which can provide power in the first time period, based on the supply-side condition. In the present embodiment, the reservation cost determination unit 654 determines, for each of one or more supply-side apparatuses mentioned above, at least one of the return power amount and the interest rate parameter which corresponds to each supply-side apparatus, based on an expected value of the power supply/demand of each supply-side apparatus in the second time period.

In an embodiment, the reservation cost determination unit 654 calculates, for each of one or more supply-side apparatuses mentioned above, an expected value of the surplus power amount of each supply-side apparatus for each unit time period included in the second time period, based on an expected value of the power supply/demand of each supply-side apparatus in the second time period, for example. The reservation cost determination unit 654 determines at least one of the return power amount and the interest rate parameter in the unit time period such that the return power amount will be larger in the unit time period as the surplus power amount of each supply-side apparatus is larger in the unit time period.

Then, the reservation management unit 652 determines one or more supply-side apparatuses which provide power to the customer facility 112, based on the return power amount or the interest rate parameter for each unit time period of the each supply-side apparatus. For example, the reservation management unit 652 determines: (i) one or more supply-side apparatuses; and (ii) the return time period and the return power amount from the customer facility 112 to each supply-side apparatus such that: (i) the total power amount which one or more supply-side apparatuses can provide in the first time period exceeds the procured power amount; and (ii) the power amount which the customer facility 112 provides in the second time period is the smallest.

This adjusts the return time period and the return power amount such that the power is returned in the time period when the supply-side apparatus has a relatively large unoccupied capacity. The reservation management unit 652 and the reservation cost determination unit 654 may perform matching with varied lengths of the unit time period to search for a combination which makes the power amount provided by the customer facility 112 in the second time period smaller.

In another embodiment, first, the reservation cost determination unit 654 calculates, for each unit time period included in the second time period, the surplus power amount of the customer facility 112 based on an expected value of the power supply/demand of the customer facility 112 in the second time period. Then, the reservation cost determination unit 654 extracts one or more candidates related to the return time period, from a plurality of unit time periods included in the second time period, based on an expected value of the surplus power amount of the customer facility 112 per unit time period.

For example, the reservation cost determination unit 654 extracts a unit time period in which the surplus power amount satisfies a predetermined condition, as a candidate of the return time period mentioned above. Examples of the predetermined condition can include a condition that the surplus power amount is larger than a predetermined threshold, a condition that a return probability determined based on the surplus power amount is larger than a predetermined threshold, or other. The reservation cost determination unit 654 may repeat the process mentioned above with varied lengths of the unit time period to determine the unit time periods which allow the total of one or more candidate time periods to be larger.

Then, the reservation cost determination unit 654 extracts an expected value of the power supply/demand of each supply-side apparatus in the respective time periods of one or more candidates related to the return time period, from information indicating an expected value of the power supply/demand of each supply-side apparatus in the second time period. The reservation cost determination unit 654 may determine, in accordance with a procedure similar to the procedure mentioned above, at least one of the return power amount and the interest rate parameter which corresponds to each supply-side apparatus, based on an expected value of the power supply/demand of each supply-side apparatus in the respective time periods of one or more candidates related to the return time period, for example.

The reservation management unit 652 determines, in a procedure similar to the procedure mentioned above, one or more supply-side apparatuses which provide power to the customer facility 112, based on the return power amount or the interest rate parameter for each unit time period of the each supply-side apparatus. In addition, the reservation management unit 652 determines, based on an arbitrary reference, the power amount supplied from each of one or more supply-side apparatuses mentioned above to the customer facility 112 in the first time period. Subsequently, the reservation management unit 652 generates one or more pieces of reservation information related to the first time period and one or more pieces of reservation information related to the second time period.

As set forth above, according to the present embodiment, the user of the energy management system 100 ensures to return the power in the future such that the power of another user or the community is provided to the user. This allows a transaction which corresponds to an advance loan in the monetary loan (which may be referred to as an advance loan of power) to be implemented in the power transaction. For example, if one user procures power from another user or the community, the one user can appropriate the power in the future of the one user to a compensation of at least a part of the procured power amount.

In a specific information processing, when the request processing unit 540 receives a request related to an advance loan of power from one user, the reservation management unit 652 reserves a power transaction in the near future (the first time period, for example) and reserves a power transaction in the far future (the second time period, for example). This realizes an advance loan of power in the power transaction, rather than merely a futures transaction of power.

If one user transacts with the community, the reservation of the power transaction in the near future may be a reservation related to the power supply from the community to the one user. In addition, the reservation of the power transaction in the far future may be a reservation related to the power supply from the one user to the community.

If one user transacts with another user, the reservation of the power transaction in the near future may be a reservation related to the power supply from another user to the one user. In addition, the reservation of the power transaction in the far future may be a reservation related to the power supply from the one user to another user.

If one user transacts with another user, the reservation of the power transaction in the near future may include: (i) a reservation related to the power supply from another user to the community; and (ii) a reservation related to the power supply from the community to the one user. In addition, the reservation of the power transaction in the far future may include: (i) a reservation related to the power supply from the one user to the community; and (ii) a reservation related to the power supply from the community to another user.

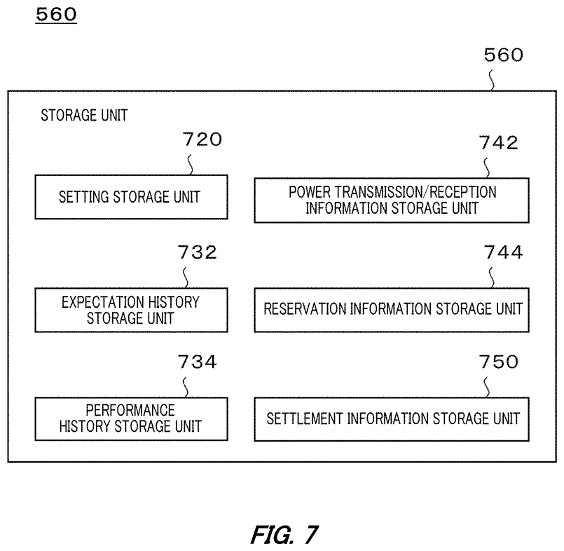

FIG. 7 schematically illustrates an example internal configuration of the storage unit 560. In the present embodiment, the storage unit 560 includes a setting storage unit 720, an expectation history storage unit 732, a performance history storage unit 734, a power transmission/reception information storage unit 742, a reservation information storage unit 744, and a settlement information storage unit 750.

Each of the setting storage unit 720, the expectation history storage unit 732, and the performance history storage unit 734 may store information similar to each of the setting storage unit 372, the expectation history storage unit 374 and the performance history storage unit 376, respectively. Each of the setting storage unit 720, the expectation history storage unit 732, and the performance history storage unit 734 may store information collected by the data collection unit 530.

In the present embodiment, the power transmission/reception information storage unit 742 stores, for each unit of the community 102, information about the power transmission/reception plan generated by the power transmission/reception planning unit 642. The power transmission/reception information storage unit 742 stores information about the power transmission/reception performance of each unit of the community 102. The power transmission/reception information storage unit 742 may store information collected by the data collection unit 530.

In the present embodiment, the reservation information storage unit 744 stores reservation information generated by the reservation management unit 652. The reservation information storage unit 744 may also store identification information of the power interchange request and identification information of the reservation information generated based on the power interchange request to be associated with each other. The reservation information storage unit 744 may also store information indicating an execution situation of each piece of reservation information.

In the present embodiment, the settlement information storage unit 750 stores information indicating a power bill of each customer facility of the community 102. The settlement information storage unit 750 may include information indicating a statement of the power bill.

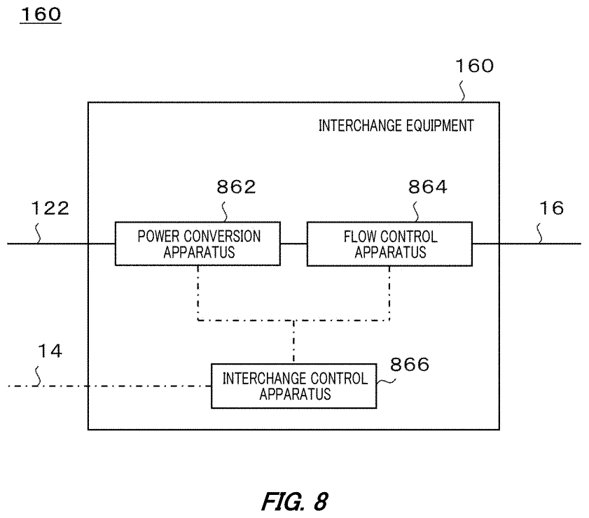

FIG. 8 schematically illustrates an example internal configuration of the interchange equipment 160. In the present embodiment, the interchange equipment 160 includes a power conversion apparatus 862, a flow control apparatus 864, and an interchange control apparatus 866.

In the present embodiment, the power conversion apparatus 862 converts a direct current to an alternate current or converts a direct current to an alternate current, under the control of the interchange control apparatus 866. The power conversion apparatus 862 converts a quality of power under the control of the interchange control apparatus 866. In an embodiment, the power conversion apparatus 862 converts at least one of a voltage and a frequency of power which flows over the power transmission/distribution network 122 and supplies the converted power to the self supporting line 16 via the flow control apparatus 864. In another embodiment, the power conversion apparatus 862 converts at least one of a voltage and a frequency of power which flows through the self supporting line 16 and supplies the converted power to the power transmission/distribution network 122 via the flow control apparatus 864.

In the present embodiment, the flow control apparatus 864 controls a power flow under the control of the interchange control apparatus 866. In an embodiment, the flow control apparatus 864 allows a current to pass in a direction from the power transmission/distribution network 122 to the self supporting line 16. In another embodiment, the flow control apparatus 864 allows a current to pass in a direction from the self supporting line 16 to the utility grid power network 12. In yet another embodiment, the flow control apparatus 864 controls an amount of the power flow.

In the present embodiment, the interchange control apparatus 866 controls power interchanged between the power transmission/distribution network 122 and the self supporting line 16. In an embodiment, the interchange control apparatus 866 controls a type and a quality of the interchanged power. In another embodiment, the interchange control apparatus 866 controls a flow direction and an amount of power. The interchange control apparatus 866 may control at least one of the power conversion apparatus 862 and the flow control apparatus 864, in accordance with an instruction of the community management server 440.

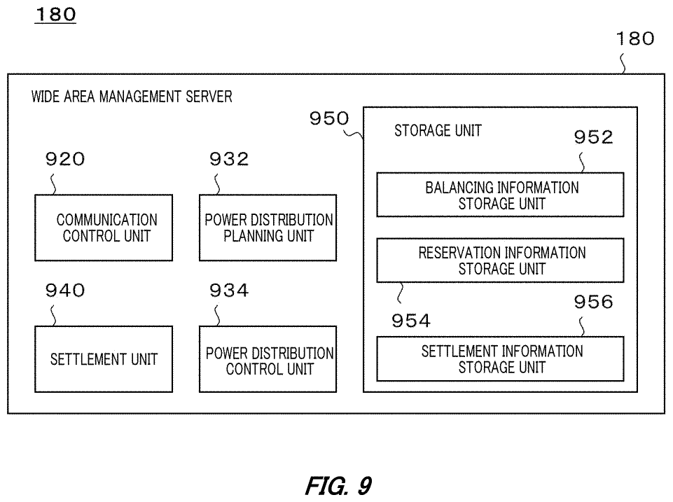

FIG. 9 schematically illustrates an example internal configuration the wide area management server 180. In the present embodiment, the wide area management server 180 includes a communication control unit 920, a power distribution planning unit 932, a power distribution control unit 934, a settlement unit 940, and a storage unit 950. In the present embodiment, the storage unit 950 includes a balancing information storage unit 952, a reservation information storage unit 954, and a settlement information storage unit 956.

In the present embodiment, the communication control unit 920 controls communication between the wide area management server 180 and the outside of the wide area management server 180. For example, the communication control unit 920 controls communication between the wide area management server 180 and each of the energy management equipment 140 of a plurality of communities. The communication control unit 920 may be a communication interface of every kind. The communication control unit 920 may support one or a plurality of communication systems.

In the present embodiment, the power distribution planning unit 932 plans power transmission/reception among a plurality of communities via the utility grid power network 12. For example, the power distribution planning unit 932 generates information including information indicating a time period when the power transmission/reception is performed, information indicating the power transmission side, information indicating the power receiving side, and a power transmission/reception amount, which are associated with one another. The power distribution planning unit 932 may plan the power transmission/reception mentioned above for each unit time period.

The power distribution planning unit 932 may plan the power transmission/reception mentioned above, based on an expected value of the power supply/demand in each of a plurality of communities. For example, the power distribution planning unit 932 obtains, from each of the community management servers 440 of a plurality of communities managed by the wide area management server 180, information indicating a plan related to the power supply/demand in the community in a predetermined time period. Examples of the plan mentioned above can include a supply/demand plan per 30 minutes in the balancing system.

If the community management server 440 of one community receives a power interchange request to request power interchange from a customer facility of the community to another community or a customer facility of another community, it transmits to the wide area management server 180 one or more pieces of reservation information generated along with the power interchange request. When the power distribution planning unit 932 receives one or more pieces of reservation information mentioned above, it stores the reservation information in the storage unit 950. In addition, the power distribution planning unit 932 transmits the reservation information mentioned above to the community management server 440 of another related community. This allows the power interchange indicated by the reservation information related to a plurality of communities to be reflected to the expected value of the power supply/demand of each of a plurality of communities.

The power distribution planning unit 932 may plan the power transmission/reception mentioned above, based on an expected value of the power supply/demand of each of a plurality of communities and reservation information generated based on the power interchange request transmitted by at least one customer facility which configures at least one community of a plurality of communities. The power distribution planning unit 932 may transmit and receive to/from a management server which manages another utility grid power network electrically connected to the utility grid power network 12, their power distribution plans.

In the present embodiment, the power distribution control unit 934 controls the power transmission/reception via the utility grid power network 12. For example, the power distribution control unit 934 monitors power demand and power supply of each community and adjusts excess or deficiency of power in the utility grid power network 12. For example, if the power distribution control unit 934 determines that the excess or deficiency of the planned value between the power supply/demand of the community 102 and the performance value of the power supply/demand meet a predetermined condition, it requests the community management server 440 of the community 102 to adjust the power supply/demand in accordance with the plan. The power distribution control unit 934 may also control the power generation equipment or the power storage equipment of a power utility which supplies power to the utility grid power network 12, such that the excess or deficiency of power in the utility grid power network 12 is resolved.

In the present embodiment, the settlement unit 940 settles, for each of a plurality of communities, the power transmission/reception between the community and the utility grid power network 12. For example, the settlement unit 940 sums up, for each of a plurality of communities, the power transmission amount and the power reception amount between the community and the utility grid power network 12 per settlement time period. The settlement unit 940 may sum up, for each of a plurality of communities, revenue and expenditure related to the power with the utility grid power network 12 per settlement time period.

In the present embodiment, the settlement unit 940 may sum up, for each of a plurality of communities, the power transmission amount and the power reception amount between the community and the utility grid power network 12 per unit time period included in the settlement time period. For example, the wide area management server 180 manages, for each of a plurality of communities, a power transmission amount per unit time period such that a sold power amount to the utility grid power network 12 and an interchange amount to the other communities are distinguished from each other. This allows the settlement unit 940 to sum up the power transmission amount per unit time period such that the sold power amount to the utility grid power network 12 and the interchange amount to the other communities are distinguished from each other.

Similarly, the wide area management server 180 may manage, for each of a plurality of communities, a power reception amount per unit time period such that a purchased power amount from the utility grid power network 12 and an interchange amount from the other communities are distinguished from each other. This allows the settlement unit 940 to sum up the power reception amount per unit time period such that the purchased power amount from the utility grid power network 12 and an interchange amount from the other communities are distinguished from each other.

The unit prices of power in power purchase and power selling may be determined for each unit time period. The unit prices of power in power purchase and power selling are determined based on the time zone, the season, a type of power generation, or other, for example. On the other hand, power may be interchanged for free of charge in power interchange between one community and the other communities. Power may also be interchanged with charge in the power interchange mentioned above. In the power interchange mentioned above, the unit prices of power in power purchase and power selling may be different from each other. The wide area management server 180 may collect a commission in power interchange between one community and the other communities. The commission may be given as a monetary value, an electronic value or a proprietary value, or may be given as a power amount.

According to the present embodiment, the settlement unit 940 can sum up the revenue and expenditure of each community in the settlement time period, based on information indicating a summary value of the power transmission amount and the power reception amount of each community per unit time period and information indicating the unit price or the commission, for example. This allows a reservation process related to power transmission/reception related to a plurality of communities generated in response to reception of the power interchange request to be realized as a process on data on the wide area management server 180.

For example, the following case is taken into consideration: in response to a power interchange request from the customer facility 112 of the community 102, a reservation is made to transmit power from the customer facility 112 of the community 102 to the customer facility 114 of the community 104 in a unit time period Pi. In this case, the wide area management server 180 determines a power bill to be paid to the community 102 by subtracting a power amount indicated by the reservation information mentioned above, from the power amount transmitted by the community 102 to the utility grid power network 12 in the unit time period Pi. In addition, the power bill to be charged to the community 104 is determined by subtracting the power amount indicated by the reservation information mentioned above, from the power amount received by the community 104 from the utility grid power network 12 in the unit time period Pi. This allows every kind of reservation processes related to the power transmission/reception to be realized as a process on data.

In the present embodiment, the storage unit 950 stores every kind of information about the power transmission/reception between the utility grid power network 12 and each of a plurality of communities. The storage unit 950 may also store every kind of information about the power interchange related to a plurality of communities.

In the present embodiment, the balancing information storage unit 952 stores information indicating a plan of each of a plurality of communities in the balancing system. The information indicating the plan mentioned above may be information indicating a planned value of the power demand amount and the power supply amount per unit time period in each community.

In the present embodiment, the reservation information storage unit 954 stores reservation information related to the power interchange request to request power interchange from the customer facility of one community to another community or a customer facility of another community. This allows the wide area management server 180 or the community management server 440 of each community to treat a part of the power supplied from one community to another community in a certain time period as the power provided by the certain customer facility of the one community to the certain customer facility of the other community.

In the present embodiment, the settlement information storage unit 956 stores information generated by the settlement unit 940. The settlement information storage unit 956 may also store, for each of a plurality of communities, information indicating of a statement of the power transmission/reception amount and information indicating a balance statement for each predetermined time period.

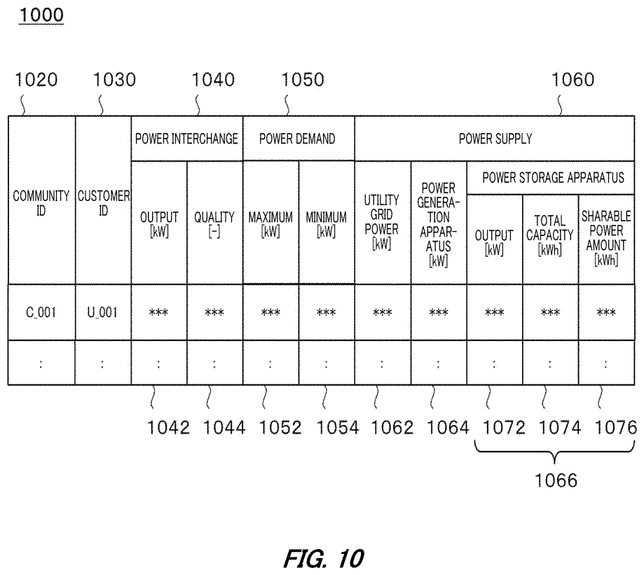

FIG. 10 schematically illustrates an example of the data table 1000. The data table 1000 may be an example of the data table which indicates a specification related to the power supply/demand of the customer facility 112. The data table 1000 is stored in the setting storage unit 372, for example. In the present embodiment, the data table 1000 stores a community ID 1020, a customer ID 1030, power interchange information 1040, power demand information 1050, and power supply information 1060, to be associated with one another.

Examples of the power interchange information 1040 can include information 1042 about an output of the interchange equipment 160, power quality information 1044 to which the power supply information 1060 can correspond, or other. Examples of the power demand information 1050 can include information 1052 about a maximum value of the power demand, information 1054 about a minimum value of the power demand, or other. Examples of the power supply information 1060 can include information 1062 about the power of the utility grid, information 1064 about the power generation apparatus, information 1066 about the power storage apparatus, or other. Examples of the information 1066 about the power storage apparatus can include information 1072 about an output of power charge/discharge, information 1074 about the total capacity, information 1076 about a power amount sharable in the community, or other.

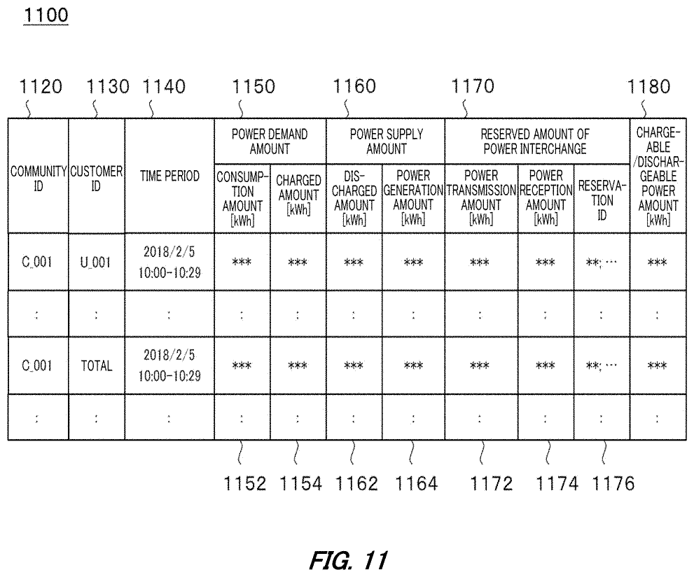

FIG. 11 schematically illustrates an example of the data table 1100. The data table 1100 may be an example of the data table which indicates every kind of performance values or expected values of the power supply/demand. The data table 1100 is stored in the expectation history storage unit 374 or the performance history storage unit 376, for example. In the present embodiment, the data table 1100 stores a community ID 1120, a customer ID 1130, information 1140 indicating a time period, information 1150 about the power demand amount in the time period, information 1160 about the power supply amount in the time period, information 1170 about a reserved amount of power interchange in the time period, and information 1180 about a chargeable/dischargeable power amount of the power storage apparatus in the time period, to be associated with one another.

The information 1150 about the power demand amount may include information 1152 about a power consumption amount of the power load 210 and information 1154 about a charged amount of the power storage apparatus 224. The information 1160 about the power supply amount may include information 1162 about a discharged amount of the power storage apparatus 224 and information 1164 about a power generation amount of the power generation apparatus 222. The information 1170 about a reserved amount of power interchange may include information 1172 indicating the power transmission amount indicated by the reservation information, information 1174 indicating the power reception amount indicated by the reservation information, and information 1176 indicating the reservation ID to identify the reservation information.

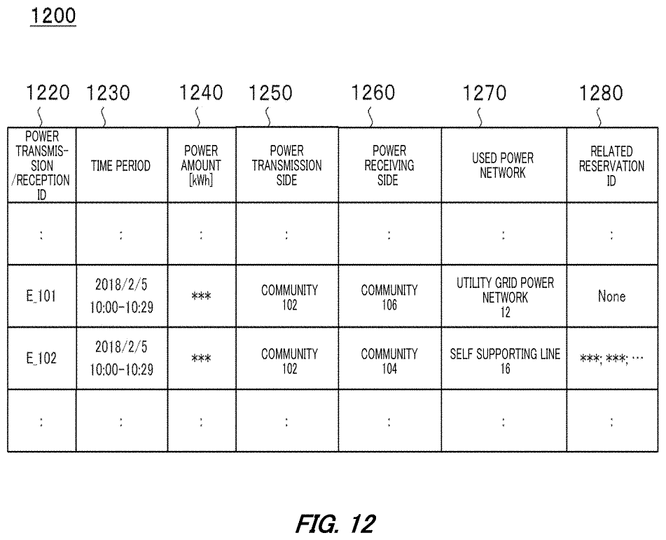

FIG. 12 schematically illustrates an example of the data table 1200. The data table 1200 may be an example of the data table which indicates every kind of performance values or expected values of the power transmission/reception. The data table 1200 is stored in the power transmission/reception information storage unit 742, for example. In the present embodiment, the data table 1200 stores a power transmission/reception ID 1220, information 1230 indicating a time period, information 1240 about the power transmission/reception amount in the time period, information 1250 about the power transmission side, information 1260 about the power receiving side, information 1270 about the power network used for the power transmission/reception, and information 1280 about the related reservation ID, to be associated with one another.

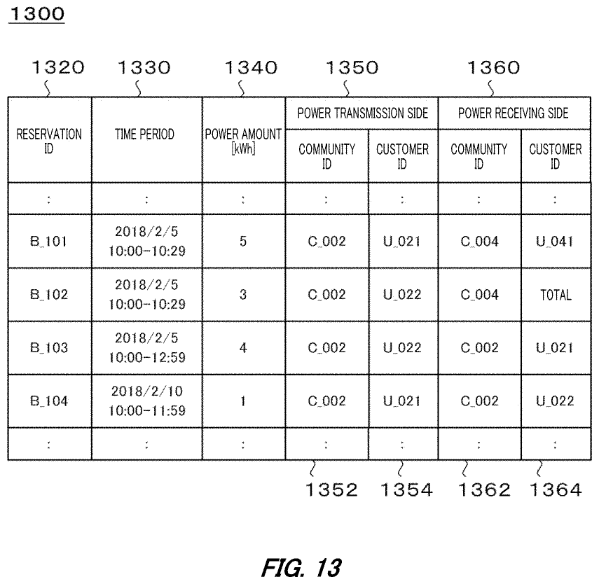

FIG. 13 schematically illustrates an example of the data table 1300. The data table 1300 may be an example of the reservation information. The data table 1300 is stored in the reservation information storage unit 744 or the reservation information storage unit 954, for example. In the present embodiment, the data table 1300 stores a reservation ID 1320, information 1330 indicating a time period, information 1340 about the power transmission/reception amount in the time period, information 1350 about the power transmission side, and information 1360 about the power receiving side, to be associated with one another. The information 1350 about the power transmission side includes a community ID 1352 and a customer ID 1354, for example. The information 1360 about the power receiving side includes a community ID 1362 and a customer ID 1364, for example.

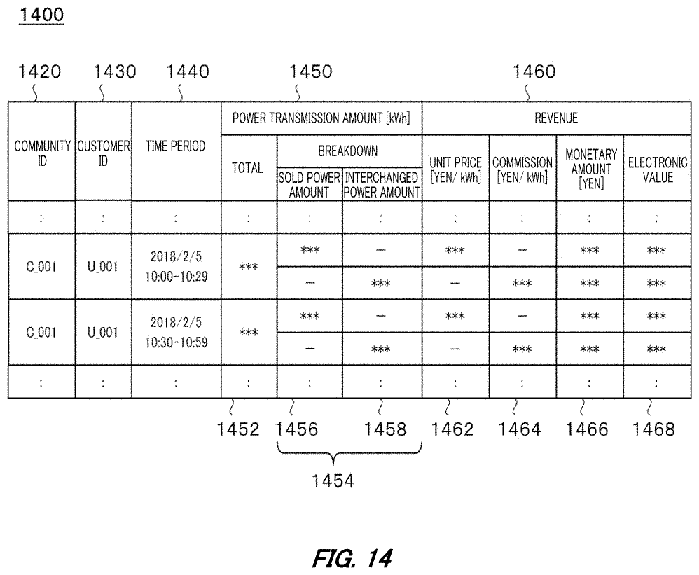

FIG. 14 schematically illustrates an example of the data table 1400. The data table 1400 may be an example of every kind of settlement information. The data table 1400 may be an example of the data table which indicates revenue of the power supply to the outside. The data table 1400 is stored in the settlement information storage unit 750 or the settlement information storage unit 956, for example. In the present embodiment, the data table 1400 stores a community ID 1420, a customer ID 1430, information 1440 indicating a time period, information 1450 about the power transmission amount in the time period, and revenue information 1460 in the time period, to be associated with one another.

The information 1450 about the power transmission amount may include information 1452 indicating the total power transmission amount in each time period and breakdown information 1454. The breakdown information 1454 may include information 1456 indicating a sold power amount and information 1458 indicating an interchange amount. The revenue information 1460 may include unit price information 1462, commission information 1464, monetary amount information 1466, and electronic value information 1468.

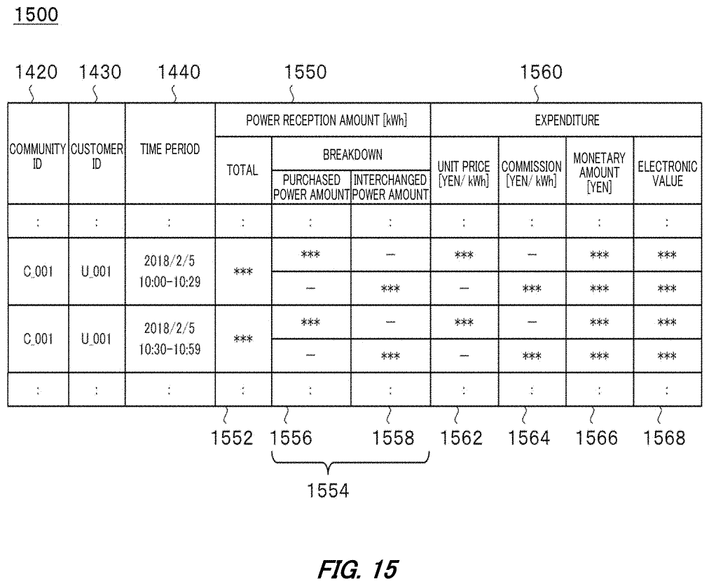

FIG. 15 schematically illustrates an example of the data table 1500. The data table 1500 may be an example of every kind of settlement information. The data table 1500 may be an example of the data table which indicates expenditure of the power supplied from the outside. The data table 1500 is stored in the settlement information storage unit 750 or the settlement information storage unit 956, for example. In the present embodiment, the data table 1500 stores a community ID 1420, a customer ID 1430, information 1440 indicating a time period, information 1550 about the power reception amount in the time period, and expenditure information 1560 in the time period, to be associated with one another. It is noted that the data table 1400 and the data table 1500 may be put together in one table.

The information 1550 about the power reception amount may include information 1552 indicating the total power reception amount in each time period and breakdown information 1554. The breakdown information 1554 may include information 1556 indicating the purchased power amount and information 1558 indicating the interchange amount. The expenditure information 1560 may include unit price information 1562, commission information 1564, monetary amount information 1566, and electronic value information 1568.

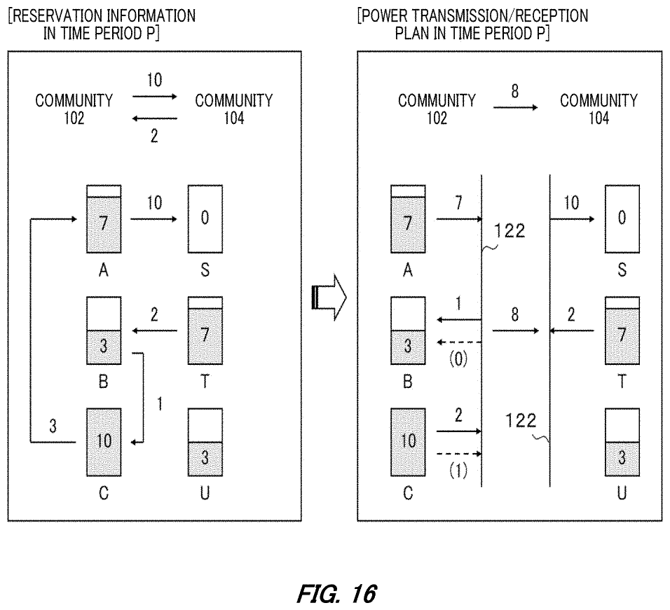

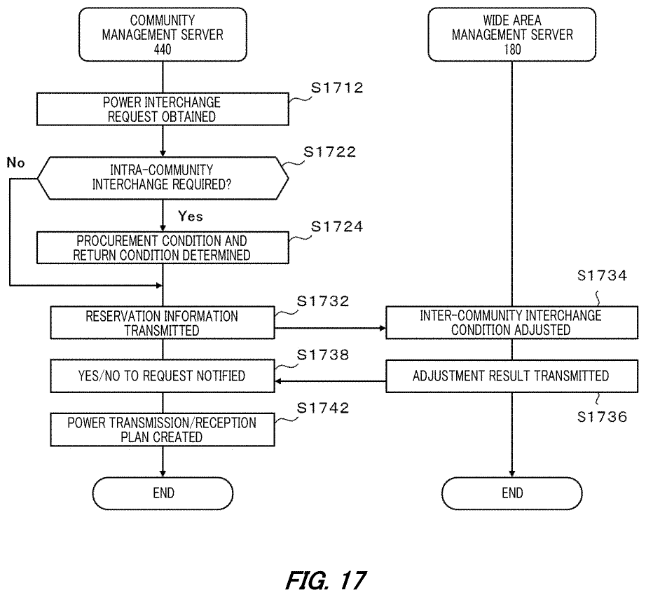

With reference to FIG. 16 and FIG. 17, schematically illustrated is an example creating method of the power transmission/reception plan. FIG. 16 schematically illustrates situations of a plurality of reservations in a time period P and an example power transmission/reception plan, taking into account the reservations. FIG. 17 schematically illustrates an example procedure related to a process of creating the power transmission/reception plan based on a plurality of pieces of reservation information.

As illustrated in FIG. 16, in the present embodiment, the community 102 includes a customer facility A, a customer facility B, and a customer facility C. The community 104 includes a customer facility S, a customer facility T, and a customer facility U. Each of the customer facility A, the customer facility B, and the customer facility C may have the configuration similar to that of the customer facility 112. Each of the customer facility S, the customer facility T, and the customer facility U may have the configuration similar to that of the customer facility 112.

According to the present embodiment, at a beginning of the time period P, an expected value of the surplus power amount of each of the customer facilities A, B and C is 7 kWh, 3 kWh, and 10 kWh. On the other hand, at the beginning of the time period P, an expected value of the surplus power amount of each of the customer facilities S, T and U is 0 kWh, 7 kWh, and 3 kWh.

In addition, in the present embodiment, in accordance with the reservation information generated before the time period P, the customer facility T is reserved to interchange power of 2 kWh to the customer facility B in the time period P. Similarly, in accordance with the reservation information generated before the time period P, the customer facility B is reserved to interchange power of 1 kWh to the customer facility C.

With reference to FIG. 17, an example information processing of the community management server 440 will be described, taking as an example the case where, in the state mentioned above, the power interchange request was transmitted from the customer facility A to the energy management equipment 140 at a time before the time period P, to request interchange power of 10 kWh to the customer facility S in the time period P. According to the present embodiment, first, at S1712 in FIG. 17, the community management server 440 of the community 102 obtains the power interchange request mentioned above output by the customer facility A of the community 102.

Then, the community management server 440 judges whether the power interchange request from the customer facility A may be accepted. Specifically, at S1722, the community management server 440 judges whether the power interchange within the community 102 is required, with regard to the power interchange request from the customer facility A.

For example, the community management server 440 compares the surplus power amount of the customer facility A at the beginning of the time period P with the power amount indicated by the power interchange request from the customer facility A. If the surplus power amount of the customer facility A at the beginning of the time period P is equal to or greater than the power amount indicated by the power interchange request from the customer facility A (NO at S1722), the community management server 440 judges that the power interchange within the community 102 is not required, with regard to the power interchange request from the customer facility A. In addition, the community management server 440 judges that the power interchange request from the customer facility A may be accepted and proceeds to the process S1732.

At S1732, the community management server 440 generates, based on the power interchange request from the customer facility A, reservation information indicating that power of 10 kWh is interchanged from the customer facility A to the customer facility S in the time period P. In addition, the community management server 440 transmits the generated reservation information to the wide area management server 180.

On the other hand, if the surplus power amount of the customer facility A at the beginning of the time period P is smaller than the power amount indicated by the power interchange request from the customer facility A (YES at S1722), the community management server 440 judges that the power interchange within the community 102 is required and proceeds to the process S1724. It is noted that, if the total surplus power amount of the community 102 at the beginning of the time period P is smaller than the power amount indicated by the power interchange request from the customer facility A, the community management server 440 may judge that the power interchange request from the customer facility A cannot be accepted. In this case, the community management server 440 may transmit to the customer facility A a message indicating that the request is not accepted and terminates the process (not illustrated in the figure).

According to the present embodiment, as illustrated in FIG. 16, the surplus power amount of the customer facility A at the beginning of the time period P (7 kWh) is smaller than the power amount indicated by the power interchange request from the customer facility A (10 kWh). Therefore, according to the present embodiment, the community management server 440 proceeds to the process S1724. At S1724, the community management server 440 performs a process for interchanging power to the customer facility A from other customer facilities within the community 102, taking as collateral the power to be provided by the customer facility A in the future, for example.

Specifically, first, the community management server 440 determines a customer facility which provides power of 3 kWh to the customer facility A in the time period P. The request processing unit 540 may determine a customer facility which provides power of 3 kWh to the customer facility A in the time period P, from among a plurality of customer facilities which configure the community 102.

In the present embodiment, the community management server 440 determines that, taking as collateral the power of 4 kWh to be provided by the customer facility A to the customer facility C in the future, the customer facility C provides power of 3 kWh to the customer facility A in the time period P, for example. This generates: (i) reservation information indicating that the customer facility C supplies power of 3 kWh to the customer facility A in the time period P; and (ii) reservation information indicating that the customer facility A supplies power of 4 kWh to the customer facility C in a time period later than the time period P.

Then, at S1732, the generated reservation information is transmitted to the wide area management server 180. At S1734, the wide area management server 180 transmits to the community management server 440 of the community 104 the reservation information transmitted from the community management server 440 of the community 102. In addition, the wide area management server 180 adjusts a condition between the community 102 and the community 104 for power interchange of 10 kWh from the customer facility A to the customer facility S in the time period P.

Specifically, the wide area management server 180 requests the community management server 440 of the community 104 to check whether the unoccupied capacity of the power storage apparatus 224 of the customer facility S is 10 kWh or more in the time period P. The wide area management server 180 may also request the community management server 440 of the community 104 to check, if the unoccupied capacity of the power storage apparatus 224 of the customer facility S is less than 10 kWh in the time period P, whether the community 104 can receive power of 10 kWh as a whole.

In the time period P, if the customer facility S or the community 104 can receive power of 10 kWh, the wide area management server 180 adjusts a specific time zone and power amount for actual power transmission/reception. For example, the wide area management server 180 receives from the community management server 440 of the community 104, a request related to the time zone for performing power transmission/reception, from among time periods included in the time period P, and the power amount. Subsequently, at S1736, the wide area management server 180 transmits the adjustment result with the community 104 to the community management server 440 of the community 102.

The wide area management server 180 may determine the net power amount to be interchanged between the community 102 and the community 104 in the time period P. In the present embodiment, the wide area management server 180 determines that the community 102 transmits power of 8 kWh to the community 104 in the time period P. The wide area management server 180 may transmit information about the net power amount mentioned above to the community management servers 440 of the community 102 and the community 104.

At S1738, the community management server 440 of the community 102 obtains from the wide area management server 180 information indicating the adjustment result with the community 104. If the information indicating the adjustment result includes information indicating that the community 104 cannot receive power of 10 kWh in the time period P, the community management server 440 of the community 102 may transmit to the customer facility A a message indicating that the request is not accepted and terminate the process.

If the information indicating the adjustment result does not include information indicating that the community 104 cannot receive power of 10 kWh in the time period P, the community management server 440 of the community 102 proceeds to the process S1742. At S1742, the community management server 440 of the community 102 generates information indicating a power transmission/reception plan in the time period P, based on a plurality of pieces of reservation information related to the time period P.

The community management server 440 of the community 102 may determine the net power amount interchanged within the community 102, between each of the customer facility A, the customer facility B and the customer facility C and the power transmission/distribution network 122 of the community 102. In the present embodiment, the community management server 440 of the community 102 determines that, in the time period P: (i) the customer facility A transmits power of 7 kWh to the power transmission/distribution network 122 of the community 102; (ii) the power transmission/distribution network 122 of the community 102 transmits power of 1 kWh to the customer facility B; and (iii) the customer facility C transmits power of 2 kWh to the power transmission/distribution network 122 of the community 102.

The community management server 440 of the community 102 may also determine the power amount interchanged between each of the customer facility A, the customer facility B and the customer facility C and the power transmission/distribution network 122 of the community 102 such that the number of customer facilities which interchange power with the power transmission/distribution network 122 of the community 102 is smaller. For example, the community management server 440 of the community 102 determines, in the time period P: (i) the customer facility A transmits power of 7 kWh to the power transmission/distribution network 122 of the community 102; (ii) power transmission/reception is not performed between the power transmission/distribution network 122 of the community 102 and the customer facility B; and (iii) the customer facility C transmits power of 1 kWh to the power transmission/distribution network 122 of the community 102.

Similarly, the community management server 440 of the community 104 may determine the net power amount interchanged within the community 104, between each of the customer facility S, the customer facility T and the customer facility U and the power transmission/distribution network 122 of the community 104. In the present embodiment, the community management server 440 of the community 104 determines that, in the time period P: (i) the power transmission/distribution network 122 of the community 104 transmits power of 10 kWh to the customer facility S; and (ii) the customer facility T transmits power of 2 kWh to the power transmission/distribution network 122 of the community 104.

According to the present embodiment, the community management server 440 of the community 102 plans the power transmission/reception within the community 102 in the time period P, based on a plurality of pieces of reservation information related to the time period P. In addition, the community management server 440 of the community 104 plans the power transmission/reception within the community 104 in the time period P, based on a plurality of pieces of reservation information related to the time period P. In addition, the wide area management server 180 adjusts the power transmission/reception between the community 102 and the community 104. This reduces the power loss in the power transmission/reception.

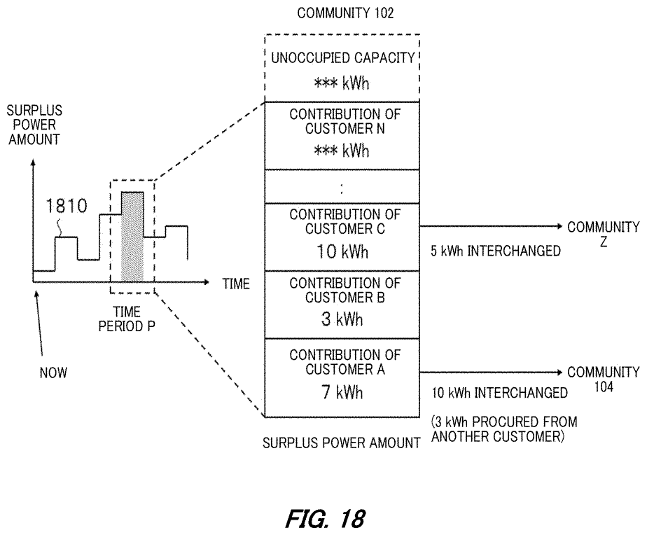

FIG. 18 schematically illustrates an example power procurement method in the community. According to the present embodiment, the community management server 440 of the community 102 expects a future surplus power amount 1810, when a predetermined event occurs. The community management server 440 of the community 102 may expect the future surplus power amount 1810 for each unit time period. Examples of the predetermined event can include: (i) reaching a predetermined clock time; (ii) lapse of a predetermined time period since the future surplus power amount 1810 was expected previously; (iii) receiving an instruction from the customer terminal 250 to expect the future surplus power amount 1810, or other.

The community management server 440 of the community 102 may calculate, for each future unit time period, a contribution degree of each customer facility to the total surplus power amount of the community 102 in the unit time period. The community management server 440 of the community 102 calculates the contribution degree of each customer facility based on at least one of: (i) the power amount provided by each customer facility to the community 102; and (ii) the performance that each customer facility accepts demand response from the community 102, for example.

This allows the community management server 440 of the community 102 to calculate the power amount which each customer facility can interchange to the other customer facilities in the time period P. In addition, the community management server 440 of the community 102 can extract a customer facility which can supply power to the other customer facilities in the time period P.

While the embodiments of the present invention have been described, the technical scope of the invention is not limited to the above described embodiments. It is apparent to persons skilled in the art that various alterations and improvements can be added to the above-described embodiments. Also, matters explained with reference to a particular embodiment can be applied to other embodiments as long as there is no technical contradiction.

In addition, as long as there is no technical contradiction, the matter described in relation to a particular embodiment can be applied to the other embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

In the present specification, the following matters are described, for example

[Item 1-1]

A condition determination apparatus that determines a power interchange condition between: (i) a first user that requires for power interchange in a first time period prior to a second time period under a condition that it provides power in the second time period; and (ii) a second user that can provide power to the first user in the first time period, the condition determination apparatus comprising:

a demand-side condition obtaining unit that obtains: (i) information for identifying the first time period; and (ii) information indicating a first target value related to a power amount provided to the first user from the second user in the first time period;

a supply-side condition obtaining unit that obtains information indicating a condition for providing power by the second user in the first time period; and

a return condition determination unit that determines at least one of: (i) a second target value related to a power amount provided to the second user from the first user in the second time period, and (ii) a parameter that indicates a relationship between the first target value and the second target value, based on the information obtained by the demand-side condition obtaining unit and the information obtained by the supply-side condition obtaining unit.

[Item 1-2]

The condition determination apparatus according to item 1-1, further comprising:

a first supply/demand expectation obtaining unit that obtains information indicating an expected value of power supply/demand of the first user in the second time period, wherein

the return condition determination unit determines at least one of the second target value and the parameter, based on the information obtained by the demand-side condition obtaining unit, the information obtained by the supply-side condition obtaining unit, and the information obtained by the first supply/demand expectation obtaining unit.

[Item 1-3]

The condition determination apparatus according to item 1-2, further comprising:

a second supply/demand expectation obtaining unit that obtains information indicating an expected value of power supply/demand of the second user in the second time period, wherein

the return condition determination unit determines, based on the information obtained by the first supply/demand expectation obtaining unit, one or more candidates that relate to time periods included in the second time period, the time periods in which the first user provides power to the second user, and

determines at least one of the second target value and the parameter, based on an expected value of power supply/demand of the second user in the respective time periods of the one or more candidates indicated by the information obtained by the second supply/demand expectation obtaining unit.

[Item 1-4]

The condition determination apparatus according to item 1-1 or item 1-2, further comprising:

a second supply/demand expectation obtaining unit that obtains at least one of: (i) information indicating an expected value of power supply/demand of the second user in the first time period; and (ii) information indicating an expected value of power supply/demand of the second user in the second time period, wherein

the return condition determination unit determines at least one of the second target value and the parameter, based on the information obtained by the demand-side condition obtaining unit, the information obtained by the supply-side condition obtaining unit, and the information obtained by the second supply/demand expectation obtaining unit.

[Item 1-5]

The condition determination apparatus according to item 1-4, wherein

the condition for providing power by the second user in the first time period includes at least one of:

(A) a condition that indicates a relationship between: (i) a situation of power supply/demand of the second user in the first time period; and (ii) at least one of the second target value and the parameter; and

(B) a condition that indicates a relationship between: (i) a situation of power supply/demand of the second user in the second time period; and (ii) at least one of the second target value and the parameter, and wherein

the return condition determination unit identifies the first time period and a power amount to be provided from the second user to the first user in the first time period, based on the information obtained by the demand-side condition obtaining unit, and

based on the expected value of power supply/demand indicated by the information obtained by the second supply/demand expectation obtaining unit and the condition indicated by the information obtained by the supply-side condition obtaining unit, determines at least one of the second target value and the parameter if the identified power amount is interchanged in the identified first time period.

[Item 1-6]

The condition determination apparatus according to any one of item 1-1 to item 1-5, wherein

the demand-side condition obtaining unit obtains information about at least one of: (i) an instruction of the first user related to an upper limit value of a power amount provided in a unit time period, if power is provided in the second time period; (ii) an instruction of the first user related to an upper limit value of the number of unit time periods in which power is provided, among one or more unit time periods included in the second time period; and (iii) a history of power interchange of the first user.

[Item 1-7]

The condition determination apparatus according to any one of item 1-1 to item 1-6, wherein

the supply-side condition obtaining unit obtains information about at least one of: (i) an instruction of the second user related to an upper limit value of a power amount provided in a unit time period, if power is provided in the second time period; (ii) an instruction of the second user related to an upper limit value of the number of unit time periods in which power is provided, among one or more unit time periods included in the second time period; and (iii) a history of power interchange of the second user.

[Item 1-8]

The condition determination apparatus according to any one of item 1-1 to item 1-7, wherein

the first user is an owner or a user of at least one of (i) a mobile device and (ii) portable device that include a storage battery, and

the second user is an owner, a manager or an operator of a charging apparatus to charge the storage battery, or a provider of power to charge the storage battery, and wherein

the second user provides power to the storage battery of the first user in the first time period.

[Item 1-9]

A program for making a computer function as the condition determination apparatus according to any one of item 1-1 to item 1-8.

[Item 1-10]

A condition determination method for determining a power interchange condition between: (i) a first user that requires for power interchange in a first time period prior to a second time period under a condition that it provides power in the second time period; and (ii) a second user that can provide power to the first user in the first time period, the condition determination method comprising:

obtaining a demand-side condition of: (i) information for identifying the first time period; and (ii) information indicating a first target value related to a power amount provided to the first user from the second user in the first time period;

obtaining a supply-side condition of information indicating a condition for providing power by the second user in the first time period; and

determining a return condition of at least one of: (i) a second target value related to a power amount provided to the second user from the first user in the second time period, and (ii) a parameter that indicates a relationship between the first target value and the second target value, based on the information obtained in the obtaining of the demand-side condition and the information obtained in the obtaining of the supply-side condition.

[Item 2-1]

A power interchange apparatus comprising:

a performance information obtaining unit that obtains, for each of a plurality of first power customers that configure a first community, information about a power interchange performance between the first power customer and the first community; and

a contribution degree determination unit that determines a contribution degree of at least one of the plurality of first power customers to a surplus power amount of the first community in a certain time period, based on information about the performance obtained by the performance information obtaining unit.

[Item 2-2]

The power interchange apparatus according to item 2-1, further comprising:

a request obtaining unit that obtains an interchange request from at least one of the plurality of first power customers, to request for interchanging at least a part of surplus power of the first community in a future time period to a second community that is different from the first community;

an expectation information obtaining unit that obtains information indicating an expected value of the surplus power amount of the first community in the future time period; and

an interchange amount determination unit that determines a power amount to be interchanged from the first community to the second community in the future time period, based on: (i) the expected value of the surplus power amount indicated by the information obtained by the expectation information obtaining unit; and (ii) the contribution degree in the future time period determined by the contribution degree determination unit.

[Item 2-3]

The power interchange apparatus according to item 2-2, wherein

the interchange request includes information indicating a target value of a power amount interchanged from the first community to the second community, and wherein

the power interchange apparatus further comprising:

a procurement judgement unit that judges, if the power amount determined by the interchange amount determination unit is smaller than the target value indicated by the interchange request, whether a first power customer that outputs the interchange request can procure power from one or a plurality of first power customers different from the first power customer in the future time period.

[Item 2-4]

The power interchange apparatus according to item 2-2 or item 2-3, further comprising a supply/demand information obtaining unit that obtains information about power supply/demand of each of the plurality of first power customers, wherein

the expectation information obtaining unit expects a surplus power amount of the first community in the future time period, based on the information about the power supply/demand obtained by the supply/demand information obtaining unit.

[Item 2-5]

The power interchange apparatus according to any one of item 2-1 to item 2-4, wherein

the contribution degree determination unit determines the contribution degree of at least one of the plurality of first power customers, based on at least one of:

(i) a power amount interchanged from each first power customer to the first community, between a reference clock time and either one of a beginning or an end of the certain time period;

(ii) a ratio of a power amount interchanged from each first power customer to the first community to a power amount interchanged from all of the plurality of first power customers to the first community, between the reference clock time and either one of a beginning or an end of the certain time period;

(iii) the number of times each first power customer interchanges power to the first community, between the reference clock time and either one of a beginning or an end of the certain time period; and

(iv) the number of times each first power customer accepts demand response from the first community, between the reference clock time and either one of a beginning or an end of the certain time period.

[Item 2-6]

The power interchange apparatus according to any one of item 2-1 to item 2-5, wherein

the information about a power interchange performance includes information in which identification information of a power transmission side, identification information of a power receiving side, information indicating a time period in which is power is interchanged, and information indicating an interchanged power amount, which are associated with one another.

[Item 2-7]

The power interchange apparatus according to any one of item 2-1 to item 2-6, further comprising: a switching unit that switches electrical connections between a power network of a commercial utility grid and a power transmission/distribution network of the first community.

[Item 2-8]

A program for making a computer function as the power interchange apparatus according to any one of item 2-1 to item 2-7.

[Item 2-9]

A power interchange method comprising:

obtaining performance information being, for each of a plurality of first power customers that configure a first community, information about a power interchange performance between the first power customer and the first community; and

determining a contribution degree of at least one of the plurality of first power customers to a surplus power amount of the first community in a certain time period, based on information about the performance obtained in the obtaining of the performance information.

### EXPLANATION OF REFERENCES

12: utility grid power network, 14: communication network, 16: self supporting line, 22: electric vehicle, 24: storage battery, 100: energy management system, 102: community, 104: community, 106: community, 112: customer facility, 114: customer facility, 120: power transformation equipment, 122: power transmission/distribution network, 140: energy management equipment, 160: interchange equipment, 180: wide area management server, 210: power load, 220: power supply equipment, 222: power generation apparatus, 224: power storage apparatus, 230: power distribution equipment, 240: controller, 250: customer terminal, 322: demand monitoring unit, 324: power generation monitoring unit, 326: power storage monitoring unit, 328: power transmission/reception monitoring unit, 340: communication control unit, 350: request processing unit, 362: supply/demand expectation unit, 364: device control unit, 370: storage unit, 372: setting storage unit, 374: expectation history storage unit, 376: performance history storage unit, 440: community management server, 520: communication control unit, 530: data collection unit, 540: request processing unit, 552: customer facility control unit, 554: community equipment control unit, 560: storage unit, 620: input/output control unit, 630: settlement unit, 642: power transmission/reception planning unit, 644: supply/demand adjustment unit, 652: reservation management unit, 654: reservation cost determination unit, 720: setting storage unit, 732: expectation history storage unit,
734: performance history storage unit, 742: power transmission/reception information storage unit, 744: reservation information storage unit, 750: settlement information storage unit, 862: power conversion apparatus, 864: flow control apparatus, 866: interchange control apparatus, 920: communication control unit, 932: power distribution planning unit, 934: power distribution control unit, 940: settlement unit, 950: storage unit, 952: balancing information storage unit, 954: reservation information storage unit, 956: settlement information storage unit, 1000: data table, 1020: community ID, 1030: customer ID, 1040: information, 1042: information, 1044: information, 1050: information, 1052: information, 1054: information, 1060: information, 1062: information, 1064: information, 1066: information, 1072: information, 1074: information, 1076: information, 1100: data table, 1120: community ID, 1130: customer ID, 1140: information, 1150: information, 1152: information, 1154: information, 1160: information, 1162: information, 1164: information, 1170: information, 1172: information, 1174: information, 1176: information, 1180: information, 1200: data table, 1220: power transmission/reception ID, 1230: information, 1240: information, 1250: information, 1260: information, 1270: information, 1280: information, 1300: data table, 1320: reservation ID, 1330: information, 1340: information, 1350: information, 1352: community ID, 1354: customer ID, 1360: information, 1362: community ID, 1364: customer ID, 1400: data table, 1420: community ID, 1430: customer ID, 1440: information, 1450: information, 1452: information, 1454: information, 1456: information, 1458: information, 1460: information, 1462: information, 1464: information, 1466: information, 1468: information, 1500: data table, 1550: information, 1552: information, 1554: information, 1556: information, 1558: information, 1560: information, 1562: information, 1564: information, 1566: information, 1568: information, 1810: surplus power amount

What is claimed is:

1. A power interchange apparatus comprising:
a performance information obtaining unit that obtains, for each of a plurality of first power customers that configure a first community, information about a power interchange performance between the first power customer and the first community;
a contribution degree determination unit that determines a contribution degree of at least one of the plurality of first power customers to a surplus power amount of the first community in a certain time period, based on information about the performance obtained by the performance information obtaining unit;
a request obtaining unit that obtains an interchange request from at least one of the plurality of first power customers, to request for interchanging at least a part of surplus power of the first community in a future time period to a second community that is different from the first community;
an expectation information obtaining unit that obtains information indicating an expected value of the surplus power amount of the first community in the future time period; and
an interchange amount determination unit that determines a power amount to be interchanged from the first community to the second community in the future time period, based on: (i) the expected value of the surplus power amount indicated by the information obtained by the expectation information obtaining unit; and (ii) the contribution degree in the future time period determined by the contribution degree determination unit.

2. The power interchange apparatus according to claim 1, wherein
the interchange request includes information indicating a target value of a power amount interchanged from the first community to the second community, and wherein
the power interchange apparatus further comprising:
a procurement judgement unit that judges, if the power amount determined by the interchange amount determination unit is smaller than the target value indicated by the interchange request, whether a first power customer that outputs the interchange request can procure power from one or a plurality of first power customers different from the first power customer in the future time period.

3. The power interchange apparatus according to claim 2, further comprising a condition determination unit that determines a power interchange condition between: (i) a first user that requires for power interchange in a first time period prior to a second time period under a condition that it provides power in the second time period; and (ii) a second user that can provide power to the first user in the first time period, wherein
the first user is a first power customer that outputs the interchange request,
the second user is the one or plurality of first power customers different from the first power customer that outputs the interchange request, and
the first time period is the future time period.

4. The power interchange apparatus according to claim 3, wherein
the condition determination unit comprises:
a supply-side condition obtaining unit that obtains information indicating a condition for providing power by the second user in the first time period; and
a return condition determination unit that determines at least one of: (i) a second target value related to a power amount provided to the second user from the first user in the second time period, and (ii) a parameter that indicates a relationship between the target value and the second target value, based on the first time period, the target value indicated by the interchange request, and the condition for providing power by the second user in the first time period.

5. The power interchange apparatus according to claim 1, further comprising a supply/demand information obtaining unit that obtains information about power supply/demand of each of the plurality of first power customers, wherein
the expectation information obtaining unit expects a surplus power amount of the first community in the future time period, based on the information about the power supply/demand obtained by the supply/demand information obtaining unit.

6. The power interchange apparatus according to claim 1, wherein
the contribution degree determination unit determines the contribution degree of at least one of the plurality of first power customers, based on at least one of:
(i) a power amount interchanged from each first power customer to the first community, between a reference clock time and either one of a beginning or an end of the certain time period;
(ii) a ratio of a power amount interchanged from each first power customer to the first community to a power amount interchanged from all of the plurality of first power customers to the first community, between the reference clock time and either one of a beginning or an end of the certain time period;
(iii) the number of times each first power customer interchanges power to the first community, between the reference clock time and either one of a beginning or an end of the certain time period; and
(iv) the number of times each first power customer accepts demand response from the first community, between the reference clock time and either one of a beginning or an end of the certain time period.

7. The power interchange apparatus according to claim 1, wherein
the information about a power interchange performance includes information in which identification information of a power transmission side, identification information of a power receiving side, information indicating a time period in which is power is interchanged, and information indicating an interchanged power amount, which are associated with one another.

8. The power interchange apparatus according to claim 1, further comprising: a switching unit that switches electrical connections between a power network of a commercial utility grid and a power transmission/distribution network of the first community.

9. A non-transitory computer readable storage medium that stores a program, wherein the program makes a computer perform a power interchange method,
the power interchange method comprising:
obtaining performance information being, for each of a plurality of first power customers that configure a first community, information about a power interchange performance between the first power customer and the first community;
determining a contribution degree of at least one of the plurality of first power customers to a surplus power amount of the first community in a certain time period, based on information about the performance obtained in the obtaining of the performance information;
obtaining an interchange request from at least one of the plurality of first power customers, to request for interchanging at least a part of surplus power of the first community in a future time period to a second community that is different from the first community;
obtaining expectation information being information indicating an expected value of the surplus power amount of the first community in the future time period; and
determining a power amount to be interchanged from the first community to the second community in the future time period, based on: (i) the expected value of the surplus power amount indicated by the information obtained in the obtaining of the expectation information; and (ii) the contribution degree in the future time period determined in the obtaining of the contribution degree.

10. A power interchange method comprising:
obtaining performance information being, for each of a plurality of first power customers that configure a first community, information about a power interchange performance between the first power customer and the first community;
determining a contribution degree of at least one of the plurality of first power customers to a surplus power amount of the first community in a certain time period, based on information about the performance obtained in the obtaining of the performance information;
obtaining an interchange request from at least one of the plurality of first power customers, to request for interchanging at least a part of surplus power of the first community in a future time period to a second community that is different from the first community;
obtaining expectation information being information indicating an expected value of the surplus power amount of the first community in the future time period; and
determining a power amount to be interchanged from the first community to the second community in the future time period, based on: (i) the expected value of the surplus power amount indicated by the information obtained in the obtaining of the expectation information; and (ii) the contribution degree in the future time period determined in the obtaining of the contribution degree.
